(19) United States
(12) Patent Application Publication
(10) Pub. No.: US 2026/0044861 A1
(43) Pub. Date: Feb. 12, 2026

(54) RECALL EXECUTION AND RECALL DECISION WORKFLOWS IN PRODUCT RECALL MANAGEMENT

(71) Applicant: Honeywell International Inc., Charlotte, NC (US)

(72) Inventors: Ankit Singh, Apex, NC (US); Varun Singh, Pune (IN); Zillery Fortner, Florence, KY (US)

(21) Appl. No.: 18/795,211

(22) Filed: Aug. 6, 2024

(51) Int. Cl. G06Q 30/014; G06Q 10/0635

(52) U.S. Cl. CPC G06Q 30/014; G06Q 10/0635

(57) ABSTRACT

Example techniques to manage product recall are described. In an example, a request is received by a recall execution sub-system to recall at least one product based on an anomaly. Upon approval, the recall is initiated. Attributes associated with manufacturing of the product are retrieved from a quality events database. One or more attributes contributing to the anomaly are identified. A determination is made if the identified attributes affect other related products. The identified attributes are communicated to a recall decision sub-system to initiate a risk assessment process for the other products. The identified attributes are made available for use in determining recall of the other products.

### BACKGROUND

A wide variety of products, including medical devices, consumable items, automotive, toys, food products, pharmaceuticals, and various types of equipment, are manufactured for release into a consumer market. These products are designed to serve various purposes and are expected to meet safety standards for use by consumers. Manufacturing process for these products is typically predefined and may involve several stages, including production, testing, and post-manufacturing activities, such as packaging and distribution. To ensure a predefined quality of a product, each activity within these stages is carried out in accordance with standard operating procedures (SOPs). For instance, the SOPs may dictate testing parameters for medical devices or storage conditions for pharmaceutical ingredients.

Despite these precautions, there may be instances where the products are discovered to be unsafe after they have been made available to consumers. Such safety concerns may arise from design oversights, production anomalies, or inadvertent use of harmful substances. When faced with these issues, manufacturers of the products may be responsible for taking corrective action, which may include initiating voluntary recall or complying with recall mandated by regulatory authorities.

The recall process, however, may be complex, requiring communication with consumers to return affected products, coordination for product returns, information dissemination, and consumer support. The financial and operational costs are substantial, including recall execution, refunds, and compensation.

A recall decision may have lasting impacts on the reputation of the manufacturer of the products to be recalled and on consumer trust. Therefore, it is important to manage the product recall in accordance with appropriate predefined processes, for instance, that comply with the regulatory requirements. Additionally, it is also pertinent to ensure that insights relating to causes that may lead to a recall are identified, recorded, and applied to the manufacturing process to avoid instances of recall in the future.

### SUMMARY

The details of some embodiments of the invention described in this specification are set forth in the accompanying drawings and the description below. Other features, aspects, and advantages of the invention will become apparent from the description, the drawings, and the claims.

The present invention relates to methods, systems, and non-transitory computer-readable media for product recall management.

According to an aspect of the present invention, the method is implemented within a product recall management system that includes two main components: a recall decision sub-system and a recall execution sub-system. Each sub-system is configured to execute specific workflows related to recall of a product. The method comprises receiving, at the recall execution sub-system, a request for the recall of the product. The request for the recall of the product is based on a detection of an anomaly associated with the product for which the request for recall has been raised. An anomaly may refer to any issue or defect that necessitates the recall of the product from the market or consumer use. The method further comprises initiating, by the recall execution sub-system, execution of the recall of the product upon approval of the request. Furthermore, attributes associated with manufacturing of the product are retrieved from a quality events database. The method further comprises identifying, from amongst the attributes, one or more attributes that contribute to the anomaly in the product. Thereafter, it is determined if the identified attributes of the product that is to be recalled also affect other products related to the product. Finally, the recall decision sub-system is communicated with the one or more identified attributes that contributed to the anomaly. This communication initiates a risk assessment process for the other related products based on the one or more identified attributes. The risk assessment process includes executing a workflow that is to decide whether a recall of these other products is required based on the shared attributes that may cause an anomaly similar to the anomaly of the product for which the request for the recall is received.

In accordance with an embodiment of the present invention, the product recall management system includes a recall execution sub-system. The recall execution sub-system is configured to receive an approval to initiate a recall of a product based on an anomaly relating to the product. The recall execution sub-system is to be used to verify the approval that is provided by a user who is authorized to attest completion of predefined steps of a workflow implemented by a recall decision sub-system of the product recall management system. The workflow implements a process of determining recall of products. Execution of the recall of the product is initiated at the recall execution sub-system based on the verification. Further, at the recall decision sub-system, from a quality events database, attributes of the product are retrieved. Herein, the attributes are associated with manufacturing of the product. The recall execution sub-system is used to identify an attribute from the retrieved attributes that contribute to the anomaly in the product. Further, at the recall execution sub-system the impact of the identified attribute on other products that are related to the product that is being currently recalled. Furthermore, the recall execution sub-system communicates to the recall decision sub-system, the identified attribute to initiate a risk assessment for the other products related to the product.

In accordance with an embodiment of the present invention, the non-transitory computer-readable medium contains instructions that enable a processing resource to receive a request to recall a batch of products identified as non-compliant based on a detected anomaly. In an example, the instructions are executable to determine the request to be approved by an authorized user. In an example, the instructions are executable to verify completion of predefined steps of a workflow implemented for determining recall of products. In an example, the instructions are executable to initiate, based on the verification, the recall of the batch of products. In an example, the instructions are executable to access a quality events database to retrieve attributes of the batch of products. The quality events database comprises attributes associated with manufacturing of the product. In an example, the instructions are executable to identify one or more attributes from the retrieved attributes of the batch of products to be associated with the detected anomaly and cause the one or more identified attributes to be available for use in a workflow implemented for determining recall of other products related to the batch of products.

As per the embodiments of the present subject matter, the risk assessment process enables the recall decision sub-system to identify other products that may be affected by the same anomaly as the product identified for recall by the recall execution sub-system.

The present subject matter thus facilitates the concurrent execution of a recall with the risk assessment of other products that may be impacted by the same anomaly. As the recall decision and recall execution phases operate simultaneously, the overall product recall process is not just expedited but also made more efficient by the simultaneous investigation of other products based on the attributes that caused the anomaly in the product determined to be recalled by the recall execution sub-system.

Additional features and advantages are realized through the concepts of the present invention. Other embodiments and aspects of the invention are described in detail herein and are considered a part of the claimed invention.

### BRIEF DESCRIPTION OF FIGURES

The following detailed description references the drawings, wherein:

FIG. 1 illustrates a block diagram of a product recall management system for managing recall of products, in accordance with an example implementation of the present invention;

FIG. 2 illustrates a network environment for implementing example techniques for product recall management, in accordance with an example implementation of the present subject matter;

FIG. 3 illustrates the product recall management system, in accordance with another example implementation of the present subject matter;

FIG. 4 illustrates a signal flow in a process to manage the recall of products, in accordance with an example implementation of the present subject matter;

FIG. 5 illustrates a method for product recall management, in accordance with an example implementation of the present invention;

FIG. 6 illustrates a flow diagram of a process of determining if attributes of a product to be recalled affect other related products, according to an example implementation of the present subject matter;

FIG. 7 illustrates a flow diagram of a process of determining a degree of similarity between attributes of a product identified to be recalled and corresponding attributes of other related products, according to an example implementation of the present subject matter;

FIG. 8 illustrates a flow diagram of a process of completing an attestation process to update predefined information in a recall decision sub-system, according to an example implementation of the present subject matter; and

FIG. 9 illustrates a computing environment for product recall management, according to an example implementation of the present invention.

In the figures, the left-most digits of a reference number identify the figure in which the reference number first appears. The same numbers are used throughout the drawings to reference like features and components.

### DETAILED DESCRIPTION

A product or batches of products may be subject to a recall by a manufacturer for various reasons, including identification of safety concerns or product anomalies that may harm consumers or expose the manufacturer to legal liability. Occasionally, recalls are also initiated due to changes in regulations, leading to non-compliance with previously compliant products. The purpose of the recall is to address these issues by withdrawing affected products from a market or by rectifying an identified anomaly.

To facilitate a recall process, manufacturers rely on product recall management systems. The product recall management systems are specialized tools designed to streamline the process of recalling a product or batches of products from the market. Typically, a recall management system comprises two primary sub-systems: a recall decision sub-system and a recall execution sub-system. The recall decision sub-system is tasked with an initial phase of deciding whether to initiate a recall for a product or batches of products. The recall decision sub-system employs workflows that provide means to collect data, conduct risk analyses, and support decision-making vis à vis the recall of the product. The recall execution sub-system, on the other hand, is configured to implement the execution of the recall once a decision has been made, providing the workflow and tools to do so.

When a complaint regarding an anomaly in a product is received, for example, from a consumer of the product, or through internal quality monitoring processes at manufacturing locations, a user at the end of the manufacturer may issue a request for an investigation of the product to the recall decision sub-system. The investigation, often referred to as risk investigation, aims to assess the validity of the anomaly, severity, and scope of the anomaly in the product that prompted the request regarding the recall of the product to be raised. The risk investigation may involve gathering inputs from users, vendors, and other stakeholders and analysing data, such as customer complaints, and safety concerns related to the reported anomaly. The goal is to determine whether the anomaly poses a risk to consumers and if the anomaly warrants a recall of the product. Based on the risk investigation, if a decision to recall the product is made, in other words, the request for the recall of the product is approved at the recall decision sub-system, a request for execution of the recall of the product is sent to the recall execution sub-system.

The recall execution sub-system provides for performing the steps necessary for completing the recall of the product. This includes notifying all stakeholders, managing the logistics of product returns, handling the affected products, maintaining accurate records of the recall process, providing customer support, ensuring regulatory compliance, and compiling reports on the progress of the recall process and outcomes.

The recall decision sub-system and recall execution sub-system are designed to function both independently and in conjunction with each other. When used independently, the recall decision sub-system may be utilized for ongoing risk assessment, data analysis, and decision support without necessarily initiating a recall. On the other hand, in cases where the recall execution sub-system is used independently, a manufacturer may initiate the recall of the product without having to first conduct the risk investigation through the recall decision sub-system. This capability of the recall execution sub-system may be valuable in situations where the manufacturer has become aware that a product or batches of products have an anomaly based on internal processes or other reasons for which there may not be a formal audit trail. The functionality of the recall execution sub-system may be used also in cases where immediate action is required due to urgent safety concerns or regulatory mandates to recall the product. This independent functionality of the recall execution sub-system allows for rapid response to critical situations, enabling the manufacturers to prioritize consumer safety and regulatory compliance even in the absence of a comprehensive risk assessment. The recall execution sub-system thus provides a mechanism for initiating recalls based on human judgment, external information, or situations where the full decision-making process may not be immediately documentable within the recall decision sub-system.

In some cases, the functionality of the recall decision sub-system and recall execution sub-system be combined to be implemented into a single flow. In the combined flow, the recall decision sub-system is used to conduct the risk assessment and based on the assessment, approval to recall the product is given. Based on this approval, an instruction is sent to the recall execution sub-system to initiate the recall process of the product

In the combined flow, the process begins when a request for a recall of a product or batches of products is received by the recall decision sub-system. Upon receiving the request, the recall decision sub-system initiates a risk investigation. This investigation is automatically converted into a recall investigation. The recall investigation proceeds through a series of steps, analyzing various data points, quality indicators, and risks associated with the product to be recalled. Based on the results of this investigation, one of two outcomes occurs. The investigation is either closed if the risk is deemed insufficient to initiate the recall or the investigation is converted into the recall to be executed if the risk assessment indicates the recall is necessary. If the recall is determined to be necessary, the recall decision sub-system generates an approval request. Upon approval within the recall decision sub-system, instructions to initiate the recall execution are sent to the recall execution sub-system. The recall execution sub-system then proceeds with the recall process, following instructions and parameters set by the recall decision sub-system. In this combined flow, the recall execution depends on approval from the recall decision sub-system. This ensures that a thorough risk assessment is conducted to determine if a recall is necessary before any recall actions are initiated. However, even in the combined flow, the decision to recall a product is performed before the execution of the recall. This means that a user may be unable to begin the product recall process using the recall execution sub-system until a decision has been made to proceed with the recall based on the findings of the risk investigation at the product recall decision sub-system.

Such an implementation of the product recall management system does not cater to situations where there may be a requirement to run a recall execution process without a corresponding recall decision process preceding the recall execution process. For example, there may exist situations that demand a recall execution process to be initiated based on a decision made independent of the corresponding recall decision sub-system of the product recall management system. For example, a hospital using a particular model of PET scanner to diagnose and monitor cancer in patients may report a technical malfunction in detector arrays of the PET scanner, which may lead to inaccurate imaging results. In this example, having confirmed the anomaly in the detector arrays, while a recall execution process to recall the reported malfunctioning PET scanner begins, a recall execution process may be needed for PET scanners of another model that incorporates similar detector arrays. In such situations, the recall execution process may not need to be preceded by a recall decision process of the recall decision sub-system. Generally available product recall management systems may, however, not allow the initiation of a recall execution process by the recall execution sub-system unless the trigger to initiate the same is received from the recall decision sub-system.

Further, in cases where a recall execution process based on a decision made outside the recall decision sub-system is initiated, generally available product recall management systems provide no mechanism for feedback from the recall execution sub-system executing such a process to be incorporated in a future risk investigation process executed by the recall decision sub-system.

Accordingly, a generally available product recall management system does not provide for the recall decision sub-system to account for attributes of a product recalled based on a decision made outside the recall decision sub-system, for example, based on a business decision. For instance, an ongoing recall, initiated directly in the recall execution sub-system, may lead to the identification of the anomalous attributes of the product that may potentially be the cause that led to the recall. There exists a possibility that other batches of the product that share anomalous attributes with the product identified to be recalled may also be affected. However, until such time that the recall execution application completes the ongoing recall process, and information about the anomalous attributes is collated and made available to the recall decision sub-system, the recall decision application does not use the anomalous attributes in the risk investigation process that may carry out for the related products in the interim. Reference is made to the above example of the PET scanner to elaborate. Upon initiation of the recall execution process to recall the malfunctioned PET scanner, in parallel, a recall decision process may be needed to evaluate whether the malfunction in the reported PET scanner is an isolated incident or indicative of a broader issue that may affect scanners of the other models. However, since the decision to recall the reported scanner was not made by the recall decision sub-system, the risk assessment that the recall decision sub-system performs for other models may be agnostic of the insight that the malfunction in the reported scanner is attributable to the detector array. With the recall decision sub-system being unaware of the anomalous attributes, the risk assessment process may not be as efficient.

Generally, the product recall management systems are not flexible to allow the recall decision sub-system and the recall execution sub-system to run independently because the recall process is sequential. The recall decision sub-system conducts a risk investigation to assess the severity and scope of an anomaly, and if a recall is warranted, the recall decision sub-system triggers the recall execution sub-system. If the recall execution sub-system is executed independently in such systems, steps of the workflow implemented by the recall decision sub-system, for example, compliance with regulatory requirements, may be skipped resulting in undesirable consequences, such as the recall process not complying with regulatory requirements.

According to example implementations of the present invention, techniques that enable the recall decision sub-system to identify other products that may be affected by the same anomaly as the product identified for recall by the recall execution sub-system are described.

In accordance with example embodiments of the present subject matter, a product recall management system enables users to initiate a recall execution for a product through a recall execution sub-system, for example, based on manually identifying the product to be anomalous, without having to perform risk and recall investigations in a recall decision sub-system. This feature enables the immediate start of a recall process for the identified anomalous product.

In an embodiment, a request for recalling a product may be received, for example, from a user at a manufacturer's end, at the recall execution sub-system. The request for recalling of the product may be an indicator that the products may be anomalous or non-compliant, necessitating a recall or further investigation. In accordance with example embodiments of the present subject matter, the recall execution sub-system may be configured to initiate the execution of recall of the product upon approval by an authorized user. As per an example implementation of the present subject matter, it is mandatory to complete an attestation process that updates predefined information about the product slated for recall within the recall decision sub-system before the recall execution sub-system can execute the recall of the product.

Further, in example embodiments, the recall execution sub-system enables the identification of other products related to the product being recalled that may be affected by the anomaly. To identify other affected products, attributes associated with the product being recalled may be retrieved from a quality events database comprising attributes associated with the manufacturing of the product. From amongst the attributes, one or more attributes that contribute to the anomaly in the product being recalled may be identified. If it is determined if the identified attributes also affect other products related to the product being recalled, the identified attributes are communicated to the recall decision sub-system.

In an example, the attributes may include the manufacturing location of the products. For instance, several complaints or requests for recall of a set of products manufactured at the same location may be reflective of this attribute, namely, the manufacturing location, to have potentially led to the anomaly. This attribute can be used to assess if the anomaly is isolated to a single set of products or if it is related to multiple set of products made at said manufacturing locations. Another example of an attribute may be consignee locations, which are destinations where the products were shipped, such as distribution centres, retailers, or hospitals. Additionally, the number of quality events, which refers to recorded incidents of quality deviations or non-conformities associated with the products, may be another attribute. Quality events may include failed tests, deviations from standard procedures, or any other incidents that could compromise the quality of the products.

The recall decision sub-system is configured to initiate a risk assessment process for other products based on the identified attributes. This risk assessment process involves executing a workflow to determine whether to recall other products that may be subject to the same anomaly that triggered the recall of the product currently identified for recall. For instance, if it is determined that the product for which the recall request is received at the recall execution sub-system was manufactured at a specific manufacturing location, then the risk assessment process may execute a workflow to decide whether to recall other products manufactured at that same location.

In accordance with example embodiments of the present subject matter, an attestation process is provided that ensures that recalls, for instance, recalls that are made independent of a preceding risk assessment process, are initiated intelligently and responsibly. This attestation process requires that predefined information related to the products to be recalled be updated in the recall decision sub-system before the recall execution sub-system can proceed with the execution of the recall of the product. For instance, regulatory requirements may mandate a predefined information related to the product, such as outcome of a quality check carried out on such products by a government agency, to be recorded for every recall process of a certain type of product, like pharmaceuticals. Such information may be updated in the recall decision sub-system to comply with regulatory requirements.

By mandating the completion of the attestation process, a checkpoint is established that may verify that the recall is warranted and that all pertinent information regarding the recall has been considered. The attestation process also serves to create a documented trail of the decision-making process, which may be valuable for determining whether to recall other products that may be subject to the same anomaly that triggered the recall of the product identified to be recalled. Also, this ensures that documentation and other due diligence processes are complied with for various purposes, such as providing all pertinent information relating to the recall to stakeholders and adherence to regulatory requirements.

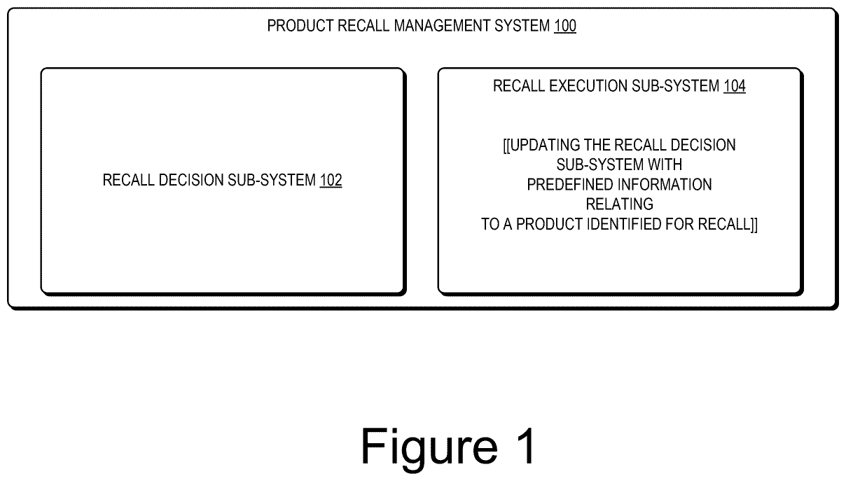

The above techniques are further described with reference to FIG. 1 to FIG. 9. It should be noted that the description and the Figures merely illustrate the principles of the present invention along with examples described herein and should not be construed as a limitation to the present invention. It is thus understood that various arrangements may be devised that, although not explicitly described or shown herein, embody the principles of the present invention. Moreover, all statements herein reciting principles, aspects, and implementations of the present invention, as well as specific examples thereof, are intended to encompass equivalents thereof.

FIG. 1 illustrates a block diagram of a product recall management system 100, in accordance with an example implementation of the present invention.

Recall processes are implemented in various industries, such as automotive, pharmaceuticals, consumer goods, electronics, and food production, to ensure consumer safety and compliance with regulatory standards. As products are designed for a wide variety of uses, the criteria and urgency for recalls vary considerably to cater to the respective safety and compliance concerns associated with each product type. A product recall management system 100 is a tool used to streamline the recall process for recalling products that are found to be defective, for example, due to an anomaly, or non-compliance with regulatory guidelines.

In an example implementation of the present subject matter, the product recall management system 100 comprises two sub-systems: a recall decision sub-system 102 and a recall execution sub-system 104. The recall decision sub-system 102 serves as a central repository for all information pertinent to a product or batches of products that may be subject to recall. The recall decision sub-system 102 provides workflows implementing processes for the collection, updating, and maintenance of predefined information related to the products, which is a prerequisite for any recall action to be taken. An example of a workflow implemented in the recall decision sub-system 102 for collection of information related to the products may comprise steps of collecting complaint reports relating to the product from consignees. The recall decision sub-system 102 may include tools, for example, data analytics tools to analyze the complaint reports to extract pertinent information related to the product. These tools, as will be understood, also comprise user interfaces that may present data to users and receive user inputs. The recall decision sub-system 102 may further include one or more databases, for example, to store data relating to the workflows and processes implemented in the recall decision sub-system 102.

The recall execution sub-system 104 implements processes for recall execution. An example of a workflow implemented by the recall execution sub-system 104 may be a process of notifying stakeholders of a decision to recall a product. The process of notifying may comprise, for example, retrieving contact information of the stakeholders to whom the notification needs to be provided from a database associated with the recall management system. Further processes may include creation of an electronic form bearing information relating to the product and questions to which inputs from the stakeholder may be requested.

In accordance with example embodiments of the present subject matter, users, such as manufacturers, consignees, and regulatory bodies may initiate a recall of a product through the recall execution sub-system 104 based on an identification of anomalies in the product. Any of the users may identify anomalies in the product manually, for instance, based on one or more complaints raised in relation to the product. The user may provide a recall request to the recall execution sub-system 104, which acts as a trigger, signaling that there may be an anomaly or non-compliance issue with the product to be recalled. The recall request, in accordance with example embodiments of the present subject matter, is based on a decision made by the user and may not be based on an outcome of a risk assessment process executed in the recall decision sub-system 102.

In accordance with an example implementation of the present subject matter, before the recall can be executed, an attestation process may be completed at the recall decision sub-system 102. This process involves updating the recall decision sub-system with predefined information relating to the product as a prerequisite to initiating a recall execution process for a product, ensuring that the decision to recall is based on the current and complete data. As described, in accordance with example embodiments of the present subject matter, recall requests may be based on a decision made by users. For such recall requests, the attestation process serves as a checkpoint to verify that all relevant information regarding the product to be recalled, for instance, predefined information required for regulatory compliance, is available and recorded.

Once the attestation process is complete, and the recall decision sub-system 102 has been updated with the predefined information, the recall execution sub-system 104 is authorized to proceed with the recall execution. This involves communicating with stakeholders, managing the logistics of the recall, and ensuring that the affected products are removed from circulation in a timely and efficient manner.

In addition to managing the recall of the identified product, the recall execution sub-system 104 may also identify other products that may be affected by the same or similar anomalies as identified in products recalled based on recall requests from one or more users. This is achieved by analyzing attributes associated with products recalled based on recall requests from one or more users. These attributes may include but are not limited to, the manufacturing location, consignee locations, and the number of recorded quality events, such as deviations from standard procedures or failed tests.

By examining these attributes, the system 100 may determine if there is a broader issue that may impact other products. For example, if multiple products manufactured at the same location are found to be defective, this could indicate a systemic problem at that manufacturing site. Similarly, if a high number of quality events are associated with products shipped to a particular consignee location, this could suggest issues with handling or storage at that destination.

The recall decision sub-system 102 may then initiate a risk assessment process for these potentially affected other products. This may involve a workflow that evaluates a likelihood and severity of risk posed by the anomaly, and whether this anomaly necessitates the recall of these potentially affected other products. Based on the outcome of this risk assessment, a decision may be taken by the user on whether to extend the recall to other products that have attributes similar to the attributes of the product to be recalled.

Thus, the product recall management system 100, with its recall decision sub-system 102 and the recall execution sub-system 104 provides a robust and intelligent mechanism for managing product recalls. This ensures that recalls are based on accurate and up-to-date information, in compliance with regulatory requirements, and that any potential risks to other products are identified and assessed, thereby safeguarding consumer safety as well as the manufacturer's interests.

In an example embodiment, each of the recall decision sub-system 102 and the recall execution sub-system 104 may have distinct functionality that may be implemented in two separate computing devices. These devices may be interfaced via a communication network (not illustrated) to work in tandem to carry out the task of recalling a product. Examples of such computing devices may include servers, workstations, desktop computers, or even high-performance laptops.

Further, while this is not depicted in FIG. 1, in an alternative embodiment, the functionality of the recall decision sub-system 102 and the recall execution sub-system 104 may be implemented in a single physical computing device. Alternatively, any combination of the functionalities may be distributed across two or more physical computing devices, depending on specific needs and resources of the user implementing the product recall management system 100.

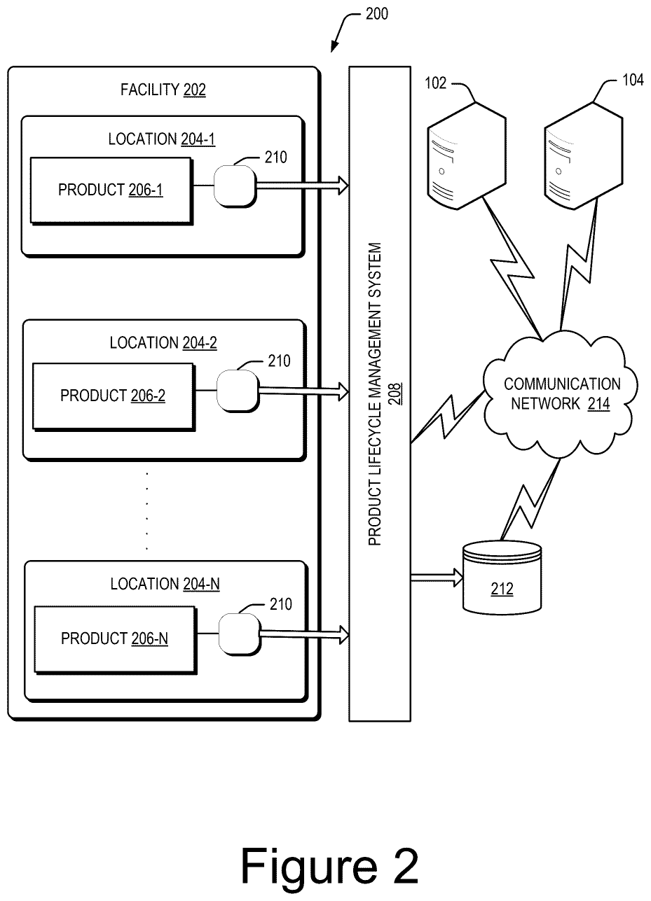

FIG. 2 illustrates a network environment 200 for implementing example techniques for product recall management, in accordance with an example implementation of the present subject matter.

A product may be an object, tool, or machine manufactured for a particular application. The application may range from use by an end user to an industrial or healthcare facility. In an example, the device may include a medical device, automobile, aircraft, household appliance, and the like. The object may also be, for example, a consumable item such as a medicinal formulation or a food item.

A product goes through various stages of a manufacturing process to make and deliver the product, such as manufacturing, testing, packaging, and distribution. Each stage of manufacturing is carried out in accordance with a standard operating procedure (SOP). A process of manufacturing or the stage of manufacturing may involve converting raw material into the product through the use of human resources, machinery, tools, and/or biological or chemical processing. The product is manufactured in accordance with the SOP defined for the respective manufacturing stage. For example, in case the product is a device, the SOP may comprise design specification of the device to be manufactured and other parameters or attributes to be followed during the manufacturing stage. The stage of the manufacturing may be followed by the stage of testing. At the stage of testing, a manufactured product may be tested to assess whether the product is performing in accordance with specified requirements. In the case of a manufactured product, for example, a medicinal composition, the properties of the medicinal composition may be tested to assess efficacy of the medicinal composition. Once tested, the product may be moved to the stage of packaging, wherein the product may be packed in accordance with safety standards, for example, as specified in a corresponding SOP. During the stage of distribution, the packed product may be transported for distribution to a deployment location wherein the product will either be used or provided to a consignee for distribution to end consumers making the product available for use. In case the product is a device, it may be deployed at the deployment location for use. Further, the product may be used at the deployment location and may undergo maintenance, if need be, during its use.

One or more of the stages of manufacturing, testing, or packaging of one or more products 206-1, 206-2, . . . 206-N may be carried out in a facility 202 of the manufacturer of the one or more products 206-1, 206-2, . . . 206-N. The facility 202 may be a manufacturing plant comprising machinery to be used for manufacturing, testing, or packaging of the one or more products 206-1, 206-2, . . . 206-N. Each stage of a process may be carried out at a designated location from amongst a plurality of locations 204-1, 204-2, . . . 204-N in the facility 202. For example, the stage of manufacturing of a product 206-1 may be carried out at a first location 204-1 and the stage of testing of another product 206-2 may be carried out at a second location 204-2, and so on.

In accordance with an example of the present subject matter, an SOP corresponding to a stage, such as the manufacturing, the testing, or the packaging of a product, such as the products 206-1, 206-2, . . . 206-N, may dictate physical conditions of activities of that stage. For example, for the manufacturing stage of a process to make a cosmetic item, the SOP may be a series of steps to combine specified quantities of ingredients in a predefined sequence and a specific manner. In an example, the SOP corresponding to a stage may also define desired ambient physical conditions, e.g., temperature and humidity, under which the product is manufactured or tested. In other words, the SOP may dictate the ambient conditions for the various stages and in turn the corresponding locations 204-1, 204-2, . . . , 204-N in the facility 202 where the different stages are performed.

In accordance with an embodiment of the present subject matter, a product lifecycle management system (PLMS) 208 may be implemented to manage the lifecycle of the product. The PLMS 208 manages the stages of manufacturing of the one or more products 206-1, 206-2, . . . , 206-N carried out in the facility 202, such that each stage of the lifecycle of the product is performed in accordance with respective SOP or the product is produced in accordance with respective SOP. In an example, the PLMS 208 may control parameters of processes carried out at each stage of the lifecycle. For example, the PLMS 208 can control speed of a mixer mixing constituents in case the product is a medicinal formulation or raw materials in case the product is a device.

The PLMS 208 may be any computing device, such as a server, a desktop computer, a laptop, a smartphone, or a tablet. The PLMS 208 may comprise one or more processors for executing instructions to manage the stages of the lifecycle of products. In an example, the processor may be implemented as microprocessors, microcomputers, microcontrollers, digital signal processors, central processing units, state machines, logic circuitries, and/or any devices that manipulate signals based on operational instructions. The PLMS 208 may comprise a memory for storing the instructions executable by the one or more processors. The instructions may cause the processor to manage at least one stage of the lifecycle of the products. The memory may include any computer-readable medium known in the art including, for example, volatile memory (e.g., RAM), and/or non-volatile memory (e.g., EPROM, flash memory, etc.). The memory may also be an external memory unit, such as a flash drive, a compact disk drive, an external hard disk drive, or the like.

In accordance with examples of the present subject matter, to manage at least one stage of manufacturing of the products 206-1, 206-2, . . . 206-N, data pertaining to the manufacturing stages of the products 206-1, 206-2, . . . 206-N may be received by the PLMS 208. This data may include information relating to the stage of manufacturing the product is currently at or the activity it is undergoing. For example, the PLMS 208 may receive, for example, through one or more physical devices 210 installed throughout the facility 202, data pertaining to location 204-1, 204-2, . . . , 204-N of the product 206-1, 206-2, . . . , 206-N. In an example, when the product is moved from one location to another location within the facility 202 as it progresses through the stages, the one or more physical devices 210 may provide to the PLMS 208, an updated location of the product 206-1, 206-2, . . . , 206-N to the PLMS 208 along with a timestamp. Based on this signaling of a change in the location of the product 206-1, 206-2, . . . , 206-N, the time spent by the product 206-1, 206-2, . . . , 206-N at a location 204-1, 204-2, . . . , 204-N within the facility 202 may be calculated by the PLMS 208, from the timestamps associated with two subsequent signals corresponding to changes in location of the product 206-1, 206-2, . . . , 206-N. The calculated time may correspond to a time spent at a stage of manufacturing carried out at the respective location 204-1, 204-2, . . . , 204-N, or, in other words, the time taken for the activities of the corresponding stage. In examples, the calculated time may indicate information, such as the time taken to assemble the product, the time taken to test the product, or the time taken to pack the product.

According to an embodiment of the present subject matter, the one or more physical devices 210 may also sense physical conditions of the stage. The physical conditions of the stage may include the environmental conditions of the respective location and operating parameters of at least one stage of the lifecycle of the product, such as manufacturing, testing, or packaging being performed at the respective location. In an example, the physical conditions of the location may include ambient temperature and humidity. For example, in a location such as a chemical lab where a medicinal composition is being produced, physical conditions may include measurements of gases, fumes, radiation, and the like. These physical conditions may be sensed by the one or more physical devices and communicated to the PLMS 208. In another example, the physical conditions of the locations 204-1, 204-2, . . . , 204-N may also include information indicative of incidents that may occur at the various locations. For example, a fire accident that occurs at a location may affect the quality of a product at or in proximity to the location. The fire accident may be detected by a fire sensor installed at the location and communicated to the PLMS 208.

Examples of the operating parameters of the stage may include sequence and time to carry out the activities of the stage, such as mixing, drying, and quenching; parameters associated with various components or equipment used to carry out the activities, such as the speed of a mixer for mixing or temperature for quenching; and attributes of the product or its constituents, such as weight or viscosity. Accordingly, the one or more physical devices 210 may be connected to the respective equipment, and the products 206-1, 206-2, . . . , 206-N to be produced to sense the variable parameters associated with the corresponding equipment. Also, in some situations, one or more physical conditions may be provided to the PLMS 208 as manual inputs. For example, reporting an incident of fire in the proximity of the product during a stage of manufacturing may be input to the PLMS 208 by a user at the manufacturer's end.

In accordance with an example implementation of the present subject matter, additional data associated with the manufacturing stages of the products 206-1, 206-2, . . . 206-N may also be provided to the PLMS 208 either manually by the user or through the one or more physical devices 210. In an example embodiment, the additional data may include information relating to product identification (ID), product type, raw material identification (ID), manufacturing location of the product, manufacturing date, manufacturing time, supplier identification (ID), and consignee locations. The product ID may refer to a unique identifier, such as an alphanumeric code, assigned to each individual product unit manufactured that may be used for tracking and differentiation of products. For example, for a PET scanner product, the product ID may be “PET-8000-2023-0142A1”, where “PET-8000” indicates model series of the PET scanner, “2023” indicates year of manufacture of the PET scanner, “0142” indicates unit number of the PET scanner, and A1 may be indicative of a manufacturing location ID. The product type may refer to a category or classification of the products, which describes general characteristics, intended use, or model designation of the products. Referring to the example of the PET scanner, the product type may be, “Medical Imaging Device.” The raw material ID may refer to a unique identifier assigned to specific batches or lots of materials used in the manufacturing process of the product. The raw material ID may be used to trace raw materials used in the manufacturing of the product. Referring to the example of the PET scanner, the raw material ID may include “CRYS-20230510”, wherein “CRYS” refers to a type of raw material used to manufacture the PET scanner, and “20230510” indicates date (May 10, 2023) when the raw material was procured or processed. The manufacturing location ID of the product may refer to the specific facility, building, room, or production line where the product was manufactured. Referring to the example of the PET scanner, the data corresponding to the manufacturing location of the PET scanner may include “Facility C, Clean Room 4, Assembly Line 2, Gurugram, Haryana, India”. The manufacturing date may refer to a calendar date on which the manufacturing process for the product was completed or the product was identified as ready for dispatch to a consignee. Further, the manufacturing time may refer to the specific time of a day, generally in hours, minutes, and seconds, when the manufacturing process for the product was completed or the product was identified as ready for the dispatch. Furthermore, supplier ID may refer to a unique code or identifier assigned to each supplier or vendor that provides raw materials to be used in the manufacturing the of the product. The consignee locations may refer to a location of consignees where the manufactured product is shipped or installed. For example, the data corresponding to the consignee location for the PET scanner may be the address of a hospital.

In accordance with an example embodiment of the present subject matter, a quality events database 212 may be created to store the data pertaining to the manufacturing stages of the products 206-1, 206-2, . . . 206-N, and the data that is recorded by the PLMS 208. In an example implementation, the quality events database 212 may be stored in the memory of the PLMS 208 or may reside in a memory of any other device, such as an external database server. Implementations where the data pertaining to the manufacturing stages of the products 206-1, 206-2, . . . 206-N and the additional data recorded by the PLMS 208 may be stored by devices other than the PLMS 208 are also possible. The different types of data associated with the manufacturing of the products 206-1, 206-2, . . . 206-N as explained previously, such as the information from the one or more physical devices 210 for checking compliance with the SOP, sensing the physical conditions and events throughout the manufacturing process, as well as all the additional data associated with the manufacturing stages of the products 206-1, 206-2, . . . 206-N, such as the supplier ID, the raw material ID, etc., as explained previously, are captured by the PLMS 208 and stored in the quality events database 212. Thus, the data stored in the quality events database 212 constitute attributes of the products 206-1, 206-2, . . . 206-N.

In accordance with an example embodiment of the present subject matter, the quality events database 212 may be accessible by the recall decision sub-system 102 and the recall execution sub-system 104 over a communication network 214. This accessibility enables parallel recall execution and recall decision workflows, as described in the present invention.

The communication network 214 may be a single communication network or a combination of multiple communication networks and may use a variety of different communication protocols. The communication network 214 may be a wireless network, a wired network, or a combination thereof. Examples of such individual communication networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NON), Public Switched Telephone Network (PSTN). Depending on the technology, the communication network 214 may include various network entities, such as gateways, routers; however, such details have been omitted for the sake of brevity of the present description.

According to an example embodiment, when a request to recall a product, such as the product 206-1, is received at the recall-execution sub-system 104, the recall execution sub-system 104 may retrieve the attributes associated with manufacturing of the product 106-1 from the quality events database 212. The recall execution sub-system 104 may then identify, from amongst these attributes, one or more attributes that contribute to an anomaly in the product 206-1 that prompted the recall request to be raised in respect of the product 206-1. For example, the product 206-1 may be a pharmaceutical tablet that is found to be too brittle or easily breakable. In this case, the anomaly may be identified as a tendency of the tablet to crumble or break apart too easily during handling or packaging, and an attribute associated with this brittleness, as deduced based on data retrieved from the quality events database 212, may be an incorrect compression force applied during a pressing stage of the tablet at a specific manufacturing location.

The recall execution sub-system 104 may determine if the identified attributes that contribute to the anomaly in the product 206-1 for which the recall request is received, also affect other products related to the product 206-1. This determination may involve assessing a degree of similarity between the identified attributes of the product 206-1 and corresponding attributes of the other related products. Referring to the previous example of the tablet, it may be determined by the recall execution sub-system 104 if other batches of tablets of the same or similar pharmaceutical composition were manufactured under the same or similar conditions of incorrect compression force. Thus, based on the initial recall request initiated due to the tablet being too brittle or easily breakable, the recall execution sub-system may check if other batches of the tablet are exposed to similar anomalous compression force during their production, potentially affecting their quality and making them prone to breaking or crumbling as well. This process allows for parallel recall execution and recall decision workflows, where the recall of one product due to an anomaly may trigger an assessment of other related products for the anomaly simultaneously.

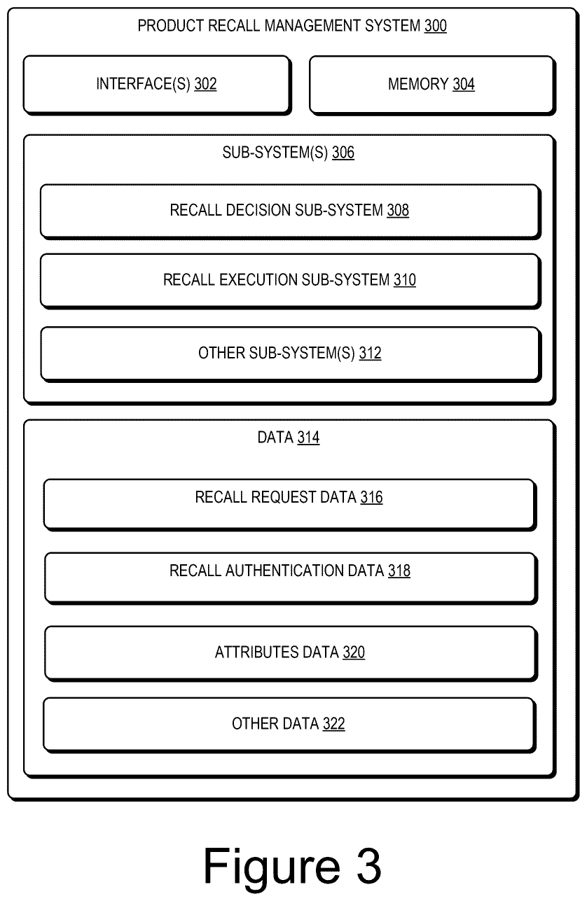

If it is determined that other products may have been affected, the recall execution sub-system 104 may communicate the identified attributes to the recall decision sub-system 102 to initiate a risk assessment process for these other related products. This risk assessment process involves executing the workflow for deciding the recall of the other potentially affected products. This communication between the recall execution sub-system 104 and the recall decision sub-system 102 exemplifies the parallel nature of the recall execution and recall decision workflows, as described in the present invention. To elaborate on the functionality of the product recall management system 100 to identify other related products or batches of products that may be impacted by attributes of the product that is identified to be recalled, reference is made to FIG. 3.

FIG. 3 illustrates a product recall management system 300 (system 300 hereinafter) that identifies, tracks, and manages the process of recalling defective or harmful products from the market, for example, to ensure consumer safety and/or regulatory compliance, in accordance with an example of the present subject matter.

In an example, the system 300 is similar to the product recall management system 100, as explained in reference to FIGS. 1 and 2. In an example, the system 300 depicted in FIG. 3 may be any computing device. Examples of the system 300 may include but are not limited to servers, desktop computers, laptops, smartphones, personal digital assistants (PDAs), and tablets.

The system 300 comprises interface(s) 302. The interface(s) 302 may include a variety of software and hardware interfaces that allow interaction of the system 300 with other communication and computing devices, such as network entities, web servers, external repositories, and peripheral devices, such as input/output (I/O) devices. For example, the interface(s) may couple the system 300 with the PMLS 208. The interface(s) 302 may also enable coupling of internal components, if any, of the system 300 with each other.

Further, the system 300 comprises a memory 304. The memory 304 may include any computer-readable medium known in the art including, for example, volatile memory, such as Static Random-Access Memory (SRAM) and Dynamic Random-Access Memory (DRAM), and/or non-volatile memory, such as Read Only Memory (ROM), Erasable Programmable ROMs (EPROMs), flash memories, hard disks, optical disks, and magnetic tapes.

The system 300 further includes sub-system(s) 306 and a data 314. The sub-system(s) 306 may be implemented as a combination of hardware and programming, for example, programmable instructions to implement a variety of functionalities of the sub-system(s) 306. In examples described herein, such combinations of hardware and programming may be implemented in several different ways. For example, the programming for the sub-system(s) 306 may be executable instructions. Such instructions in turn may be stored on a non-transitory machine-readable storage medium which may be coupled either directly with the system 300 or indirectly (for example, through networked means). In an example, the sub-system(s) 306 may include a processing resource, for example, either a single processor or a combination of multiple processors, to execute such instructions. In the present examples, the processor-readable storage medium may store instructions that, when executed by the processing resource, implement the sub-system(s) 306. In other examples, the sub-system(s) 306 may be implemented as electronic circuitry.

The sub-system(s) 306 includes a recall decision sub-system 308, a recall execution sub-system 310, and other sub-system(s) 312. In an example, the recall decision sub-system 308 and the recall execution sub-system 310 are similar to the recall decision sub-system 102 and the recall execution sub-system 104, respectively, explained in reference to FIGS. 1 and 2. The other subsystem(s) 312 may further implement functionalities that supplement applications or functions performed by the system 300 or any of the sub-system(s) 306 of the system 300. The data 314, on the other hand, includes data that is either stored or generated as a result of functionalities implemented by the system 300 or any of the sub-system(s) 306. It may be further noted that information stored and available in the data 314 may be utilized by the sub-system(s) 306 for executing recall of a product upon identifying an anomaly in the product, while simultaneously determining what other products or batches of products may be affected by the same anomaly that triggered the recall of the product.

In an example, the data 314 may comprise recall request data 316, recall authentication data 318, attributes data 320, and other data 322. The data 314 serves, amongst other things, as a repository for storing data that may be fetched, processed, received, or generated by one or more of the sub-system(s) 306.

In an example implementation of the present subject matter, a request to recall a product or batches of products may be received at the recall execution sub-system 310. The request to recall may be raised based on identification of an anomaly in the product or the batches of products. In some embodiments, the anomaly may be identified through internal processes implemented by the manufacturer of the product, or based on complaints from third parties due to reasons for which there may not be a formal audit trail. For example, the anomaly in the product may be identified based on informal feedback from end-users, spot checks, or observations for which there may be no audit trail. The request to recall the product may also be raised when immediate action is required due to urgent safety concerns or regulatory mandates to recall the product. For example, the urgent safety concerns may correspond to situations where an anomaly or a hazard in the product is discovered that poses an immediate risk to consumer safety, thereby requiring the recall of the product. Likewise, regulatory mandates, where a regulatory body, such as the Food and Drug Administration (FDA), Consumer Product Safety Commission (CPSC), or other relevant authority, issues a directive requiring the recall of the product, may lead to urgent action to recall a product. These situations may arise from sudden discoveries of potential harm to consumers, unexpected regulatory changes, or emergent quality issues that demand immediate attention to ensure public safety and compliance with regulations.

In some embodiments, the request to recall the product may be received from a manufacturer of the product or a user authorized by the manufacturer of the product. In an example embodiment, the user may be an employee of the manufacturer or a consignee. The consignee, in this context, may refer to a party to whom products of the batches of products are shipped or consigned by the manufacturer, such as a distributor, retailer, or other business partners who have been authorized by the manufacturer to initiate recall procedures if necessary.

In some embodiments, the user who raises the request to recall the product may be prompted by the recall execution sub-system 310 to provide predefined recall information related to identification of the product to be recalled. A recall form may be provided through a user interface (UI) of the recall execution sub-system 310 to allow the user to provide the predefined recall information, for example. Since the request to recall the product may be raised at the recall execution sub-system 310 without prior risk investigation on the product, the predefined recall information collected when the request is raised may help determine necessary identification details that may be required to execute the recall request. In an example, the predefined recall information to be provided by the user at the time of raising the request for the recall of the product may include, but is not limited to, product specific details (e.g., product name, stock-keeping unit, universal product code, batch numbers), and consignee information. The predefined recall information may be stored in the memory 304 of the product recall management system 300 as the recall request data 316.

According to an example embodiment of the present subject matter, the recall execution sub-system 310 executes a workflow to recall the product, with each step of the workflow handled by an authorized person whose role may be based on predefined rules. This structure ensures that a checklist provided at each step in the recall execution sub-system is complete before a process in the recall execution sub-system proceeds to the next step. A user interface (UI) may be provided in the recall execution sub-system 310 to enable the authorized person to access the recall execution sub-system 310 to complete the tasks assigned to their respective roles. This UI may allow authorized individuals to view relevant information, complete required tasks, and progress through the recall execution process efficiently and securely.

Accordingly, in an example, a recall project manager (RPM), who may be an authorized person to process the recall request at the recall execution sub-system 310, may create an initial recall request based on complaints or other relevant information, initiating a recall workflow. In accordance with example embodiments of the present subject matter, the recall execution sub-system 310 may be configured to initiate execution of the recall of the product only upon approval of the initial request by relevant stakeholders. Thus, a notification regarding the initial request for the recall may be sent by the RPM to an executive manager (EM) through the UI of the recall execution sub-system 310 for approval. The EM may be a person authorized to approve the request for the recall of the product.

In an example, a predefined role of the RPM may be to conduct a check on the status of investigations regarding the recall request and the current state of the recall. The RPM may append a report or associated snapshots of dashboards and visuals to the EM along with a notification for the approval of the recall request. The report and visuals may convey information, such as the extent of the product anomaly, potential risks to consumers, the number of affected products, geographical distribution of the affected products, and preliminary impact assessments on brand reputation and financial implications, for example. This ensures that the EM is aware of the current state of a decision to recall the product, which may help the EM make the decision regarding approval of the request and also avoid mistakes in further communications with press, media, internal stakeholders, end customers, regulatory bodies, etc., regarding the recall of the product. Based on the report from the RPM, the EM may approve the request for the recall of the product.

According to an example implementation of the present subject matter, once the EM approves the request to recall the product, a notification may be sent to the RPM. The RPM or any authorized user who may be authorized to handle the execution of the recall process at the recall execution sub-system 310 may start with the recall process. The operation of the recall execution sub-system 310 to carry out the recall execution constitutes a recall execution phase. The recall execution phase may include an attestation process to be completed prior to initiation of the recall execution, for instance, by notifying third parties of the recall of the product. The attestation process may constitute multiple action items that may need to be completed before the execution of the product recall is initiated. The action items may refer to specific tasks, or activities assigned to authorized users within the recall management process. The action items may represent discrete steps that need to be completed as part of the recall workflow. In an embodiment, a process owner may be identified for completing specific action items of the recall execution based on their expertise, role, or authority level at the recall execution sub-system 310. In some embodiments, for each action item of the recall execution, the respective process owner identified for completing that action item may be prompted by the recall execution sub-system 310 to provide predefined information pertaining to the product identified to be recalled. The predefined information collected from the process owner may be stored as the recall authentication data 318.

In an example embodiment, the predefined information collected at the recall execution phase may correspond to information usable by the recall decision sub-system 308 to carry out the risk investigation to identify other related products or batches of products that may be impacted by attributes of the product that is identified to be recalled. Therefore, to update the predefined information in corresponding fields at the recall decision sub-system 308, the action items assigned to each authorized process owner for the recall execution may be synchronized with the corresponding action items for the authorized process owner from the decision phase of the workflow at the recall decision sub-system 308. Once the predefined information is updated at the recall execution phase, the same may also be updated in the recall decision sub-system 308. For example, an action item at the recall execution phase may involve collecting detailed manufacturing data for the recalled product, such as batch numbers, production dates, raw material sources, and location of consignees. This information, when collected and updated in the recall execution sub-system 310, may be automatically synchronized with the recall decision sub-system 308.

In an example embodiment of the present subject matter, this synchronization between the action items defined for the recall execution phase and the corresponding action items in the decision phase managed by the recall decision sub-system 308 may be achieved by creating business rules that prevent action items from process owners at the recall execution phase from being completed if they have dependencies on action items from the process owners at a recall decision phase at the recall decision sub-system 308 and vice versa. This synchronization may be accomplished by defining and mapping action item dependencies from both phases at a business admin level for the product recall management system 300. Such an approach may prevent a recall from being incorrectly executed in parallel and may provide a way to incorporate governance while maintaining flexibility in the recall process.

In some embodiments, the business rules for synchronization may include, but are not limited to, a process owner to process owner dependency, action item category to action item category dependency, and AI comprehension-based rules. In the process owner to process owner dependency, a process owner from the recall execution phase may only be able to mark their action item as complete if the corresponding process owner from the recall decision phase has marked their action item as complete or at least acknowledged and started the risk evaluation process from the recall decision sub-system 308. Further, in the action item category to action item category dependency, static definitions of action item dependencies may be established, where one action item gates another action item. For example, a “Product Identification” category in the recall decision phase may gate the “Inventory Assessment” category in the recall execution phase. This means that action items within the “Inventory Assessment” category cannot be started or completed until all action items within the “Product Identification” category are finished. Furthermore, the AI comprehension-based rules may include sentiment analysis thresholds associated with an action item from the recall execution phase that may trigger action item completion from the decision phase. For example, an action item in the recall execution phase may involve collecting and analyzing customer feedback regarding the recalled product. The AI system may perform sentiment analysis on this feedback, assigning sentiment scores to each piece of feedback. If the average sentiment score falls below a predetermined threshold (e.g., −0.7 on a scale from −1 to 1), it may automatically trigger the completion of a corresponding action item in the decision phase, such as “Reassess Recall Scope.” In this scenario, if customer feedback is overwhelmingly negative, indicating potential wider issues or more severe problems than initially identified, the system 300 may prompt the manufacturer to reevaluate the scope of the recall. This automated trigger based on sentiment analysis ensures that critical information from the execution phase rapidly influences decision-making, allowing for quick adjustments to the recall strategy where necessary.

The completion of the attestation process may be verified by a user authenticated to access the recall decision sub-system 308 of the product recall management system 300. The completion of the attestation process may involve the user at the recall decision sub-system 308 indicating to the recall execution sub-system 310 that the recall decision sub-system 308 has been updated with the predefined information pertaining to the product identified to be recalled. In an example, this indication may be in the form of a notification, a status update, or a specific action within the recall decision sub-system 308. Once the user verifies the completion of the attestation process, the execution of the recall of the product may be started at the recall execution sub-system 310.

While the execution of the recall of the product is ongoing, a determination may be made to assess other products or batches of products that may be potentially affected by the same anomaly as that of the product under recall. In accordance with an example embodiment of the present subject matter, the recall execution sub-system 310 may make such a determination based on the attributes associated with manufacturing of the product identified to be recalled. For this purpose, the recall execution sub-system 310 may interact with the quality events database 212 over the communication network 214 to retrieve the attributes associated with the manufacturing of the product identified to be recalled. The attributes of the product retrieved from the quality events database 212 may be stored locally in the memory 304 of the product recall management system 300 as the attributes data 320 for further processing. From amongst the attributes of the product that are retrieved from the quality events database 212, one or more attributes that contribute to the anomaly in the product are identified by the recall execution sub-system 310. In an example, the attributes of the product contributing to the anomaly in the product may be attributes that are not in accordance with the SOP. Based on such anomalous attributes being identified, presence of similar anomalous attributes in other products related to the product identified for recall may aid in determining if the other products are potentially affected by the same anomaly as that of the product already identified for the recall.

For example, the product identified to be recalled may be a pharmaceutical tablet. The recall execution sub-system 310 may query the recall request data 316 and determine that the pharmaceutical tablet is requested to be recalled due to an anomaly of excessive brittleness or easy breakability. Based on the attributes of the pharmaceutical tablet retrieved from the quality events database 212, the recall execution sub-system 310 may determine, for instance, that three specific attributes, namely, compression force, moisture content, and binder concentration, are not in accordance with the SOP. Once these attributes are identified to be potentially contributing to the anomaly of the excessive brittleness, other products that have common values for these three attributes and may exhibit the anomaly of the excessive brittleness may be identified.

According to an example implementation of the present subject matter, once the anomalous attributes are determined, the recall execution sub-system 310 may determine if these anomalous attributes exist in other products related to the product identified for the recall. The other products to be considered may be products having attributes common with the attributes of the product identified to be recalled. These common attributes may include, but are not limited to, manufacturing location, raw materials ID, production date range, or specific manufacturing processes.

In doing so, the recall execution sub-system 310 accesses attributes of the other products related to the product identified for the recall. The attributes of the other products may be accessed by retrieving them from the quality events database 212. Once the attributes of the other products are retrieved, they may be compared with the corresponding anomalous attributes. Based on this comparison, the recall execution sub-system 310 may assess a degree of similarity between the identified attributes that contribute to the anomaly in the product to be recalled and the corresponding attributes of the other related products. In some embodiments, the degree of similarity between the identified anomalous attributes and the corresponding attributes of the other related products may be based on a weightage assigned to each of the one or more identified attributes. In an example, the weightage assigned to each of the one or more identified attributes may be configurable based on a user input, for example, based on the input of the RPM or the manufacturer of the product.

In one example, after assessing the degree of similarity, the recall execution sub-system 310 may determine if the identified attributes affect other products related to the product identified to be recalled. This determination may be based on a predefined threshold of similarity. If the degree of similarity exceeds this predefined threshold, the recall execution sub-system 310 may flag the related product as potentially affected.

In some embodiments, a similarity score may be used to quantify the degree of similarity. In this approach, each attribute may be assigned a score based on its similarity to the corresponding attribute of the product to be recalled. The similarity score may then be weighted according to the weightage assigned to each attribute by the user and summed to produce an overall similarity score for each related product. If the overall similarity score exceeds the predefined threshold, then the recall execution sub-system 310 may determine that the identified attributes of the product to be recalled also affect other products related to the product to be recalled. In some embodiments, the user may then, through the UI of the recall execution sub-system 310, communicate the one or more identified anomalous attributes that affect the other products to the recall decision sub-system 308. This communication, in one example implementation, initiates a risk assessment process for the other products based on the one or more identified attributes. In an example, the risk assessment process may comprise execution of a workflow for deciding whether to recall the other products by relying on the identified anomalous attributes that affect the other products and the recall authentication data 318.

For example, a pharmaceutical company may decide to recall batch A of tablets due to a manufacturing defect. The batch A may have the following attributes: raw material supplier A, manufacturing date: 2023 May 1, compression force of 100 kN. The recall execution sub-system 310 is used to identify another related batch B of tablets with attributes: raw material supplier A, manufacturing date: 2023 May 3, and compression force of 105 kN. Based on inputs from the user, the recall execution sub-system 310 may assign a weightage to each attribute based on perceived importance of the attributes. For instance, the raw material supplier may be given a weightage of 0.5, the manufacturing date may be given a weightage of 0.3, and the compression force may be given a weightage of 0.2. The recall execution sub-system 310 calculates similarity scores for each attribute. The similarity score for the raw material supplier may come out to be 100% as the same supplier has been used for batch A and batch B. The similarity score for the attribute manufacturing date may come out to be 90% as both batches have been manufactured with a 2-day difference. The attribute of compression force may have a similarity score of 95%. The overall similarity score may be calculated as: (0.5×100%)+(0.3×90%)+ (0.2×95%)=0.50+0.27+0.19-0.96 or 96%. Assuming the predefined threshold to be 90%, the recall execution sub-system may flag batch B as a potentially affected batch since the similarity score of 96% of batch B exceeds the predefined threshold. The recall execution sub-system 310 may then communicate this information to the recall decision sub-system 308 through the UI, initiating a risk assessment process for batch B to determine if it should also be recalled.

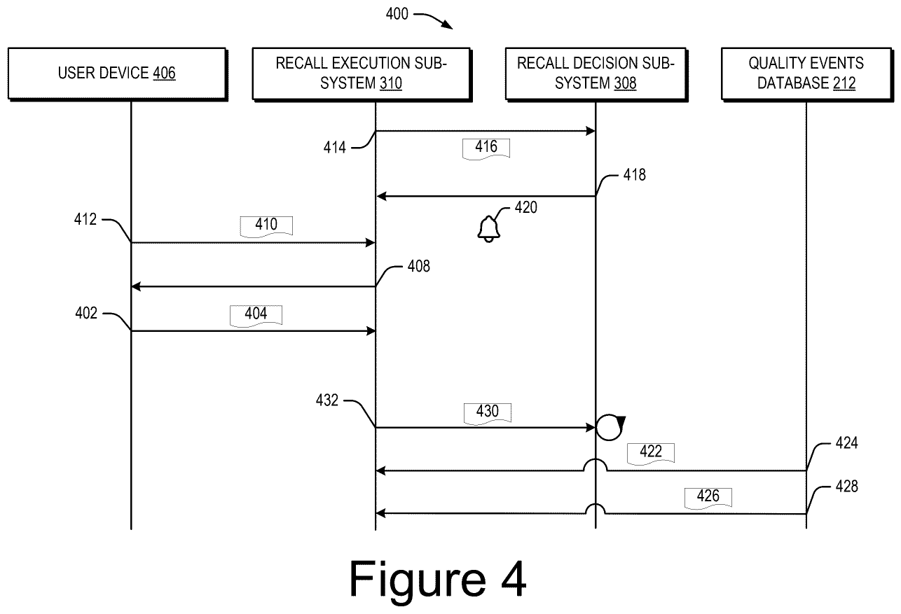

FIG. 4 illustrates a signal flow diagram 400 depicting signal flow in a process to manage recall of a product or batches of products, in accordance with an example implementation of the present subject matter.

As explained previously, in certain circumstances, a product or batches of products may need to be recalled from the market, for example, due to identification of an anomaly or regulatory requirements. The product recall management system 300 may be implemented to manage this recall process. In some cases, a decision to recall a product may be made outside the product recall management system 300 without conducting a risk assessment, resulting in no audit trail of causes contributing to the anomaly in the product that led to the recall. Nevertheless, the manufacturer may wish to execute the recall while simultaneously determining what other products or batches may be affected by the same anomaly. This parallel process may allow the manufacturer to take appropriate actions, such as recalling other affected products, in a timely manner. To achieve this, as explained previously, action items at each process owner at an execution phase of the recall may be synchronized with action items at process owners from a recall decision phase of the workflow.

In an example, in a process to implement this synchronization, when a complaint regarding an anomaly in a product is received, for example, from a consumer of the product, or through internal quality monitoring processes at manufacturing locations of the product, or to comply with regulatory requirements, a user at the end of the manufacturer may issue a request 404 for recall of the product, as indicated in step 402. In an example, the request 404 may be raised by the user using a user device 406 that may be interfaced with the product recall management system 300. Examples of the user device 406 may include but are not limited to, electronic devices, such as a desktop computer, a laptop, a smartphone, a personal digital assistant (PDA), a tablet, and other industrial secured and hardened handheld devices such as Honeywell Dolphin CT60®. Alternatively, the request 404 may be raised directly through the UI provided by the recall-execution sub-system 310. As explained previously, the user raising the request 404 to recall the product may be an employee of the manufacturer or a consignee. The consignee, in this context, may refer to a party to whom products of the batches of products are shipped or consigned by the manufacturer, such as a distributor, retailer, or other business partners who have been authorized by the manufacturer to initiate procedures if necessary.

As explained previously, when the user initiates the request 404 to recall the product, the recall execution sub-system 310 prompts the user to provide a predefined recall information 410, as indicated in step 408. The predefined recall information 410 may be similar to the predefined recall information explained in reference to FIG. 3. The user then provides this information via the user device 406, as indicated in step 412. This predefined recall information 410 may be required for effectively executing the product recall, particularly when the request 404 is initiated outside the product recall management system 300 without prior risk assessment. The requested predefined recall information 410 may include identification details of the product, such as product name, stock-keeping unit, universal product code, batch numbers, consignee information, and complaints received regarding the product. As explained previously, the recall execution sub-system 310 stores this predefined recall information 410 in the memory 304 of the product recall management system 300 as the recall request data 316.

As discussed, the recall execution sub-system 310 implements the workflow for executing product recalls, with each step managed by an authorized user based on predefined rules. This ensures completion of a checklist for each step of the workflow before advancing to the next step. Upon receiving the request 404 and the predefined recall information 410, the recall execution sub-system 310 forwards these to an RPM for processing. The RPM creates an initial recall request based on the received information, initiating the recall workflow. The recall process begins after relevant stakeholders approve the initial request. The RPM sends a notification to an EM for approval, who is authorized to approve the initial recall request.

Once the EM approves the initial request, the RPM is notified and the RPM or any authorized user may initiate the recall process through the recall execution sub-system 310. This begins a recall execution phase, including an attestation process with multiple action items to be completed before the product recall execution. Action items are assigned to authorized users based on their expertise, role, or authority.

For each action item, the recall execution sub-system 310 may prompt the respective process owner to provide predefined information pertaining to the product identified for recall. In an example, the predefined information collected at the recall execution phase may correspond to information usable by the recall decision sub-system 308 to carry out the risk investigation to identify other related products or batches of products that may be impacted by the anomaly affecting the product identified for recall. The predefined information may include but is not limited to, detailed product specifications, manufacturing location and date, raw materials used and their sources, production line information, quality events data, batch numbers, distribution information, nature and extent of the identified anomaly, any observed patterns or trends related to the anomaly.

In an example, in some cases, the process owner may be able to provide the predefined information directly from the recall request data 316. In other cases, the process owners may be subject matter experts who are aware of technical aspects of the product recall. For example, the process owner may analyze the anomaly to identify a root cause of the anomaly, and thus, may analyze the nature of the identified anomaly to provide the predefined information. This predefined information may then be stored as the recall authentication data 318.

In an example, to synchronize the predefined information between the recall execution sub-system 310 and the recall decision sub-system 308, the action items assigned to each authorized process owner for the recall execution may be aligned with the corresponding action items from the decision phase of the workflow at the recall decision sub-system 308. The predefined information updated during the recall execution phase, as depicted by 410 in FIG. 4, may also be automatically updated in the recall decision sub-system 308, as indicated in step 414. For instance, if an action item at the recall execution phase involves gathering specific manufacturing data for the product to be recalled (such as batch numbers, production dates, raw material sources, and consignee locations), this information, once collected and updated in the recall execution sub-system 310, may be automatically synchronized with the recall decision sub-system 308.

In an example embodiment of the present subject matter, the synchronization between the action items in the recall execution phase and corresponding items in the recall decision phase may be achieved through business rules. These business rules may prevent the completion of action items by process owners in the recall execution phase if they depend on uncompleted action items from process owners in the recall decision phase managed by the recall decision sub-system 308, and vice versa. This synchronization is implemented by defining and mapping action item dependencies across both phases at a business admin level of the product recall management system 300.

In some embodiments, the business rules for synchronization may include process owner to process owner dependency, action item category to action item category dependency, and AI comprehension-based rules. In the process owner to process owner dependency, a recall execution phase process owner may only complete their action item if the corresponding recall decision phase process owner has completed or at least started their risk evaluation process in the recall decision sub-system 308. The action item category to action item category dependency establishes static definitions where one action item gates another. This enables a backward workflow, allowing risk investigation of other products or batches with attributes similar to the recalled product. This backward flow facilitates the investigation of potentially affected products based on information from explicitly identified defective products, without individual risk investigations for each related product.

In an example, a user authenticated to access the recall decision sub-system 308 may verify the completion of the attestation process, allowing the product recall execution to proceed. This verification may involve the user confirming, through a notification 420, that the recall decision sub-system 308 has been updated with the predefined information about the product identified for the recall, as indicated in step 418. Upon verification of the completed attestation process, the recall execution may begin at the recall execution sub-system 310.

Concurrent with the execution of the recall process of the product identified for the recall, an assessment may be made of the other products or batches potentially affected by the same anomaly. The recall execution sub-system 310 may make this determination based on the manufacturing attributes of the recalled product. To this end, the recall execution sub-system 310 may interact with the quality events database 212 over the communication network 214 to retrieve attributes 422 associated with manufacturing of the product identified for the recall, as indicated in step 424. From the retrieved attributes 422, the recall execution sub-system 310 may identify one or more attributes contributing to the product anomaly. These anomalous attributes may be those not in accordance with the SOP.

According to an example implementation of the present subject matter, once the anomalous attributes of the product to be recalled are determined, the recall execution sub-system 310 may determine if these anomalous attributes exist in other products related to the product identified for the recall. The other products to be considered may be products having attributes common with the attributes of the product identified to be recalled. These common attributes may include but are not limited to manufacturing location, raw materials ID, production date range, or specific manufacturing processes.

In doing so, the recall execution sub-system 310 may retrieve attributes 426 of other products related to the recalled product from the quality events database 212, as indicated in step 428. These attributes 426 are then compared with the corresponding anomalous attributes of the recalled product. Based on this comparison, the recall execution sub-system 310 assesses degree of similarity between the identified anomalous attributes and the corresponding attributes 426 of related products. In some embodiments, this degree of similarity may be based on weightage assigned to each identified attribute. After assessing the degree of similarity, the recall execution sub-system 310 may determine if the identified attributes affect other related products. This determination may be based on a predefined similarity threshold. If the degree of similarity exceeds this threshold, the recall execution sub-system 310 may flag the related product as potentially affected. The weightage assigned to identified attributes and the predefined similarity threshold may be configurable based on user input, such as input from the RPM or product manufacturer.

In some embodiments, a similarity score may quantify the degree of similarity. Each attribute may be assigned a score based on its similarity to the corresponding attribute of the product to be recalled. These scores may be weighted according to user-assigned weightage to the attribute and summed to produce an overall similarity score for each related product. If this overall score exceeds the predefined threshold, the recall execution sub-system 310 may determine that the identified attributes of the recalled product also affect the related products. For example, if product A is identified for recall and product B is a related product that shares a high similarity in manufacturing location and production date, but differs in raw material supplier, product B may still receive a high overall similarity score. This may trigger a risk assessment process for product B at the recall decision sub-system 308, potentially leading to its recall as well, without needing to conduct an entirely separate investigation from scratch for product B.

In some embodiments, the user may communicate the identified anomalous attributes affecting other products, depicted by 430 in FIG. 4, to the recall decision sub-system 308, for example, through the UI of the recall execution sub-system 310, as indicated in step 432. Based on these identified anomalous attributes 430 and the recall authentication data 318, the recall decision sub-system 308 may initiate a risk assessment process for the other products. This process may determine if other products face the same anomaly and if they need to be recalled.

This allows for the execution of the recall process for the initially identified product while parallelly deciding what other products or batches may be affected by the same anomaly, essentially running both the recall decision and the recall execution processes in parallel. This parallel processing enables efficient identification and assessment of potentially affected other products, facilitating timely decision-making on whether additional recalls are necessary.

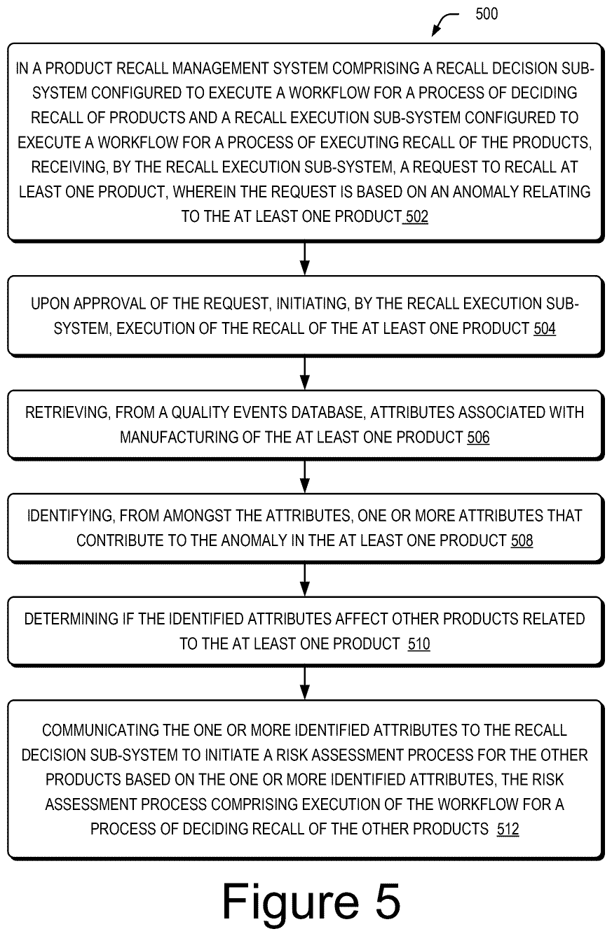

FIG. 5 illustrates a method 500 for product recall management, according to an example implementation of the present subject matter. Although the method 500 may be implemented in a variety of computer-based systems, for ease of explanation, the present description of the example method 500 for managing recall of a product is provided in reference to the above-described system 100, 300.

The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or a combination thereof.

It may be understood that blocks of the method 500 may be performed by programmed computing devices. The blocks of the method 500 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

At block 502, a request to recall a product or batches of the product is received. This request may be received by a recall execution sub-system, such as the recall execution sub-system 104, 310 explained in reference to example implementations illustrated in FIGS. 1-4. As explained previously, the request to recall the at least one product may be raised due to an anomaly identified in the product, where the anomaly may refer to any issue or defect that necessitates the recall of the product from the market or consumer use. Alternatively, the request to recall the product may be raised to comply with regulatory requirements.

At block 504, upon approval of the request, execution of the recall of the product may be initiated, for example, by the recall execution sub-system 310. In an example, it is possible to initiate the recall process by providing a request from a source other than the recall decision sub-system 308 to the recall execution sub-system 310. This request may be based on the identification of the anomaly outside of the recall decision sub-system 308, for example, based on complaints received from end consumers or internal processes of a manufacturer of the product.

At block 506, attributes associated with the manufacturing of the product are retrieved from the quality events database 212, for example, by the recall execution sub-system 310. The recall execution sub-system 310 may use these attributes to determine if other products or batches may be affected by the same anomaly as the product identified for the recall.

At block 508, from amongst the retrieved attributes, one or more attributes that contribute to the anomaly in the product identified for recall may be identified, for example, by the recall execution sub-system 310. In an example, the attributes of the product contributing to the anomaly may be those that are not in accordance with the SOP.

At block 510, it is determined whether the one or more identified attributes of the product to be recalled also affect other products related to the product to be recalled. For example, if the attributes that contribute to the anomaly in the product are a result of a one-time error by an operator during manufacturing of the product or if an isolated incident, such as a fire incident during manufacturing of the product impacted the identified attributes of the product, these attributes may not be considered as attributes contributing to the anomaly in other products. However, if it is determined that a batch of tablets was manufactured using a specific batch of raw materials or was produced on a particular production line, then these may be determined as attributes potentially affecting the other products.

At block 512, if it is determined that the one or more identified attributes may impact other products, the one or more identified attributes may be communicated to the recall decision sub-system 308 to initiate a risk assessment process for the other products based on the one or more identified attributes. This risk assessment process involves executing a workflow to determine whether to recall other products that may be subject to the same anomaly that triggered the recall of the product currently identified for the recall. This communication may trigger a risk assessment process at the recall decision sub-system 308 for other products or batches of products that may have been manufactured under similar conditions or using the same production line. The recall decision sub-system 308 may then execute its workflow to assess the risk associated with these other products and determine if additional recalls are necessary.

Thus, the example method 500 may utilize the existing product recall management system not only for handling individual product recalls, but also for assessing potential anomalies in other related products. This approach may allow for leveraging a single, integrated system that combines both recall execution and risk assessment processes. By doing so, the method may enhance overall operational efficiency and potentially reduce the complexity and resources typically associated with maintaining separate workflows for different aspects of product recall management.

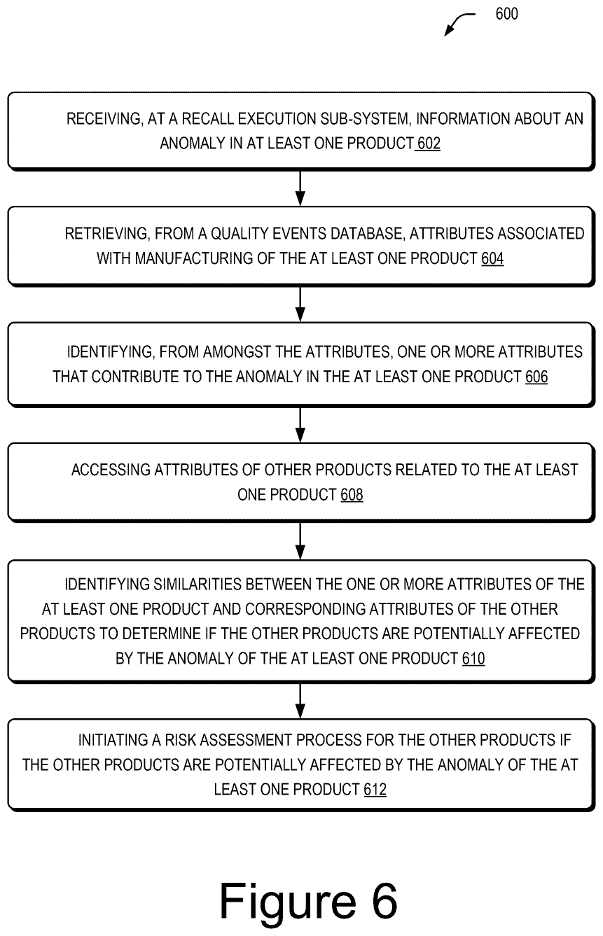

FIG. 6 illustrates a flow diagram of a process 600 for determining if attributes of a product or batches of products that are identified for a recall outside the product recall management system 300 also affect other products or batches of products related to the product identified for the recall, according to an example implementation of the present subject matter. The order in which the above-mentioned process is described is not intended to be construed as a limitation, and some of the described process blocks may be combined in a different order to implement the process, or an alternative process.

Furthermore, the above-mentioned process 600 may be implemented in suitable hardware, computer-readable instructions, or a combination thereof. The steps of such a process may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer readable and encode computer-executable instructions, where the instructions perform some or all the steps of the above-mentioned methods. In an example, the process 600 may be implemented by the system 100, 300 of FIGS. 1-4.

Referring to FIG. 6, at block 602, information about an anomaly in at least one product may be received, for example, at the recall execution sub-system 310. In an example, when an anomaly is identified in a product that necessitates recall of the product, the information regarding the same may be communicated by a user to the recall execution sub-system 310 along with a request to initiate recall of the product. To enter the information, a recall form may be provided through a UI of the recall execution sub-system 310 to allow the user to provide the information regarding the anomaly. The information about the anomaly may include details related to identification of the product to be recalled, referred to as predefined recall information in the explanation of FIGS. 1-4. The predefined recall information to be provided by the user at the time of entering the information regarding the anomaly in the product may include, but is not limited to, product-specific details (e.g., product name, stock-keeping unit, universal product code, batch numbers), and consignee information. The predefined recall information may be stored in the memory 304 of the product recall management system 300 as the recall request data 316.

At block 604, attributes associated with the manufacturing of the product to be recalled may be retrieved from the quality events database 212. These attributes may be retrieved after receiving approval on the recall request. As explained previously, once the approval is received, the recall execution sub-system 310 may then initiate the recall execution phase, which includes an attestation process involving multiple action items assigned to authorized users. The collected information is stored as the recall authentication data 318 and synchronized between the recall execution sub-system 310 and the recall decision sub-system 308.

At block 606, from amongst the attributes of the product to be recalled, one or more attributes may be identified that contribute to the anomaly in the product. These attributes contributing to the anomaly in the product may be those that are not in accordance with the SOP. For example, in a batch of pharmaceutical products identified for recall, an attribute contributing to an anomaly may be a deviation in mixing time of active ingredients. If the SOP specifies a mixing time of 30 minutes, but the actual mixing time for the batch of the pharmaceutical product was 45 minutes, this deviation may be identified as an attribute contributing to the anomaly.

At block 608, attributes of other products related to the product to be recalled may be accessed from the quality events database 212, for example, by the recall execution sub-system 310. The attributes of these other products may share commonalities with the attributes of the product identified for recall. These common attributes may include, but are not limited to, manufacturing location, raw materials ID, production date range, or specific manufacturing processes. For example, if a product to be recalled was manufactured at a specific facility, the recall execution sub-system 310 may access attributes of all products manufactured at that same facility.

At block 610, similarities between the one or more attributes of the product to be recalled and corresponding attributes of the other product may be identified to determine if the other products are potentially affected by the anomaly, for example, by the recall execution sub-system 310. For example, identifying the similarity may involve comparing the attributes of the other products with the corresponding attributes of the product identified for the recall that contributes to the anomaly of the product to be recalled. Based on this comparison, the recall execution sub-system 310 may assess a degree of similarity between the identified attributes that contribute to the anomaly in the product to be recalled and the corresponding attributes of the other related products.

At block 612, a risk assessment process may be initiated for the other products, for example, at the recall decision sub-system 308, if these other products are identified as potentially affected by the recall execution sub-system 310. This risk assessment process may involve a workflow that evaluates the likelihood and severity of risk posed by the anomaly, and whether this anomaly necessitates the recall of these potentially affected products. The assessment may consider factors such as the degree of similarity to the recalled product, the nature of the anomaly, and potential impact on product safety or efficacy. Based on the outcome of this risk assessment, the manufacturer may decide whether to extend the recall to other products that have attributes similar to those of the product initially identified for recall. This process may facilitate an efficient investigation of other products potentially affected by the attributes contributing to the anomaly in the product identified for the recall. By eliminating the need for individual risk investigations for each other related product from scratch, this approach may prevent unnecessary parallel recall executions.

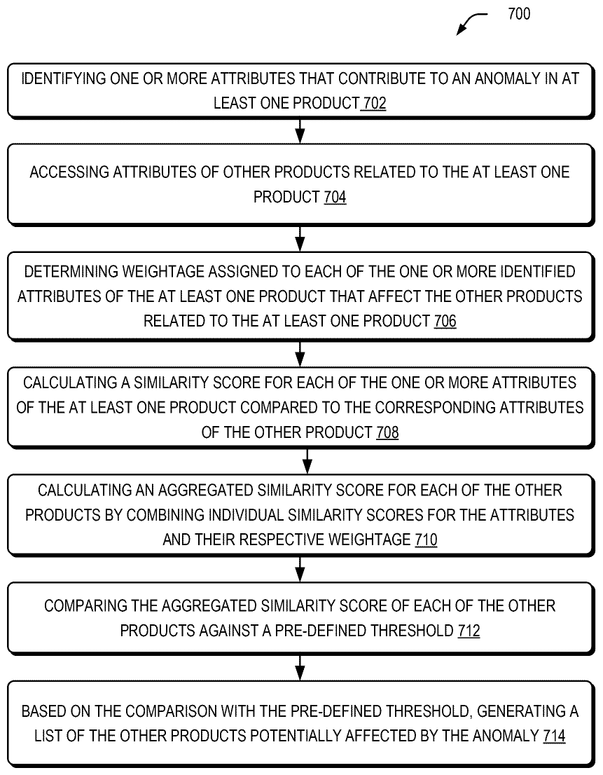

FIG. 7 illustrates a flow diagram of a process 700 for determining a degree of similarity between one or more identified attributes of a product or batches of products to be recalled and corresponding attributes of other related products, according to an example implementation of the present subject matter. This process enables the recall execution sub-system 310 to efficiently identify potentially affected products by comparing their attributes to those of the product or batches identified for the recall. The order in which the above-mentioned process 700 is described is not intended to be construed as a limitation, and some of the described process blocks may be combined in a different order to implement the process or an alternative process.

Furthermore, the above-mentioned process may be implemented in suitable hardware, computer-readable instructions, or a combination thereof. The steps of such a process may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer readable and encode computer-executable instructions, where the instructions perform some or all the steps of the above-mentioned methods. In an example, the process 700 may be implemented by the system 100, 300 of FIGS. 1-4.

Referring to FIG. 7, at block 702, one or more attributes that contribute to an anomaly in the product to be recalled are identified, for example, by the recall execution sub-system 310. The step 702 is similar to steps 508 and 606 explained in reference to FIGS. 5 and 6.

At block 704, attributes of the other products related to the product to be recalled may be accessed from the quality events database 212, for example, by the recall-execution sub-system 310. The attributes of these other products may share commonalities with the attributes of the product identified for the recall. The step 704 is similar to the step 608 explained in reference to FIG. 6.

At block 706, a weightage assigned to each of the one or more identified attributes of the product to be recalled that affect the other related products may be determined, for example, by the recall execution sub-system 310. The weightage may reflect a relative importance or impact of each attribute in determining the similarity between products. For example, attributes such as manufacturing location or production date may be assigned higher weightage if they are identified to be more critical in identifying potentially affected other products. As explained previously, the weightage assigned to each of these identified attributes may be configurable based on user input, such as input from the RPM or the product manufacturer. In some implementations, the recall execution sub-system 310 may also suggest the weightage of each attribute based on historical data or predefined rules, which may then be fine-tuned by the user.

At block 708, a similarity score is calculated for each of the one or more attributes of the product to be recalled compared to the corresponding attributes of the other products related to the product to be recalled, for example, by the recall execution sub-system 310. For example, when comparing attributes related to the manufacturing of the product, such as temperature or pressure, a score of 100% may be assigned for an exact match, while deviations may result in lower scores. That is, a product manufactured at 150° C. may have a 100% similarity score with another product made at the same temperature, but only a 90% score with one made at 145° C., and a 50% score with one made at 130° C. and so on. Similarly, for the pressure attribute, a product manufactured at 2 atm may have a 100% similarity score, while those made at 1.9 atm or 2.1 atm may have a similarity score of 95%, and those at 1.5 atm or 2.5 atm may have a similarity score of 75% and so on. Thus, the similarity score provides a measurable indication of how closely the attributes of the other products align with those of the product to be recalled, facilitating the identification of the other products that may be affected by the anomaly of the product to be recalled.

At block 710, an aggregated similarity score for each of the other products is calculated by combining individual similarity scores for the attributes and their respective weightage. This calculation may involve integrating the similarity score of each attribute by its assigned weightage and then summing these weighted scores to produce the aggregated similarity score or an overall similarity score for each related product. For example, if an attribute has a similarity score of 0.8 and a weightage of 0.6 assigned based on the user input, its contribution to the aggregated score would be 0.48. This process is repeated for all attributes, and the results are summed to yield the final aggregated similarity score.

At block 712, the aggregated similarity score of each of the other products is compared against a pre-defined threshold. The pre-defined threshold may be set based on historical data, industry standards, or regulatory requirements. This pre-defined threshold may vary depending on the type of the product, the severity of the potential anomaly, and the risk tolerance of the manufacturer. The comparison process may categorize the products into different risk levels. For example, products with aggregated similarity scores above the threshold may be flagged as high-risk and prioritized for immediate investigation or potential recall. Those with scores below but close to the threshold may be classified as moderate risk, potentially requiring closer monitoring or additional testing. The products with scores well below the pre-defined threshold may be considered low risk but may still be subject to routine monitoring. This risk categorization allows for a systematic approach to managing potential issues across a range of related products.

At block 714, based on the comparison with the pre-defined threshold, a list of the other products potentially affected by the anomaly may be generated, for example, by the recall execution sub-system 310. The list may be organized hierarchically based on the degree of similarity to the recalled product. In an example, the products with aggregated similarity scores above the highest threshold may be placed at the top of the list, indicating the highest priority for immediate action. In another example, the products with scores falling between different threshold levels may be categorized accordingly, allowing for efficient resource allocation and action prioritization, ensuring critical issues are addressed first while maintaining oversight of lower-risk products. For example, in a scenario with thresholds set at 0.8 (high risk), 0.6 (moderate risk), and 0.4 (low risk), the products may be listed in descending order of their scores, with their risk levels clearly indicated, facilitating quick identification and appropriate response to potential issues across the product range. In some embodiments, the list may be communicated to the recall decision sub-system 308 to initiate a risk assessment process for the other products. The risk assessment process may involve executing a workflow to determine whether to recall other products that may be subject to the same anomaly that triggered the recall of the product currently identified for the recall. The recall decision sub-system 308 may then execute its workflow to assess the risk associated with these other products and determine if additional recalls are necessary.

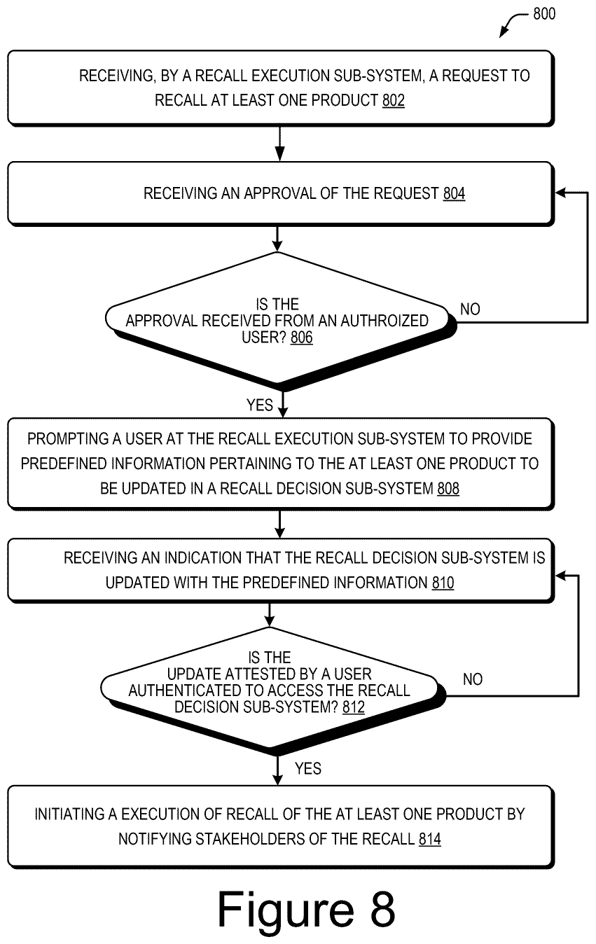

FIG. 8 illustrates a flow diagram of a process 800 of completing an attestation process to update predefined information pertaining to the product or batches of product in a recall decision sub-system, according to an example implementation of the present subject matter. The order in which the above-mentioned process 800 is described is not intended to be construed as a limitation, and some of the described process blocks may be combined in a different order to implement the process or an alternative process.

Furthermore, the above-mentioned process may be implemented in suitable hardware, computer-readable instructions, or a combination thereof. The steps of such a process may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer readable and encode computer-executable instructions, where the instructions perform some or all the steps of the above-mentioned methods. In an example, the process 800 may be implemented by the system 100, 300 of FIGS. 1-4.

Referring to FIG. 8, at block 802, a request to recall a product is received, for example, at the recall execution sub-system 310. The request may be based on a detection of an anomaly in the product, where the anomaly may refer to any issue or defect that necessitates the recall of the product from the market or consumer use. For example, in a pharmaceutical manufacturing facility, the recall execution sub-system 310 may receive a request to recall a batch of tablets. This request may be triggered by various factors, including customer complaints, internal quality control findings, or regulatory alerts. The request may be initiated after multiple reports of adverse reactions from patients using tablets from the batch of tablets, for example. In an example, an RPM may create an initial recall request based on complaints or other relevant information received regarding the recall through email, initiating the recall workflow.

As explained previously, the recall execution sub-system 310 may be configured to begin the recall process only after relevant stakeholders of the recall process approve the initial request. As explained, the recall execution sub-system 310 implements the workflow for executing the recall of the product, where each step may be managed by an authorized user based on predefined rules. This is to ensure that a checklist associated with each step is completed before the recall process advances to the next step. At block 804, an approval of the request is received from a user of the recall execution sub-system 310. Based on the initial request of the RPM, the recall execution sub-system 310 sends a notification regarding the initial recall request to an EM for approval. The EM may be authorized to approve the initial recall request. Accordingly, at block 806, an assessment is made as to whether the approval is received from the authorized user, i.e., the EM. If it is determined that the approval is not received from the authorized user, the process 800 moves back to block 804. This ensures only properly authorized personnel can approve the recall request. If the assessment is affirmative, the process 800 proceeds to block 808.

At block 808, a user is prompted, for example, by the recall execution sub-system 310, to provide predefined information about the product to be recalled for updating in the recall decision sub-system 308. This initiates the recall execution phase, including an attestation process with multiple action items. As explained previously, at this stage, process owners are assigned specific tasks based on their expertise. The predefined information may include product specifications, manufacturing details, raw materials, quality events data, and anomaly information. This information, stored as the recall authentication data 318, is used by the recall decision sub-system 308 to investigate risks to related products. Synchronization between the recall execution sub-system 310 and the recall decision sub-system 308 is maintained through aligned action items and business rules, ensuring coordinated recall management. For example, a pharmaceutical company identifies a product for recall-pain relief tablet XYZ, batch number PR-2023-0501. When prompted by the recall execution sub-system 310, the user provides predefined information to be updated in the recall decision sub-system 308. This information may include product details (name, batch number, manufacturing date, expiration date, lot size), specifications (active ingredient, concentration, packaging), distribution information, reason for recall (20% higher active ingredient concentration), detection details, potential health risks, adverse event reports, manufacturing specifics (facility, production line, raw material supplier), other batches that are identified to be affected, regulatory notifications, and initial risk assessment. This predefined information may enable the recall decision sub-system 308 to later conduct a thorough risk assessment to determine the recall scope and investigate potential impacts on related products or batches.

At block 810, an indication is received, for example, at the recall execution sub-system 310, that the recall decision sub-system 308 is updated with the provided information. For example, this indication may include receiving a notification from a user of the recall decision sub-system 308 that the predefined information has been successfully incorporated into the system's database. In an example, the notification may be received in the form of an automated message displayed on the UI of the recall execution sub-system 310, an email sent to the RPM of the recall execution sub-system 310, or a status update within the recall execution sub-system 310 itself. This indication ensures that all relevant information about the product identified for the recall has been properly recorded and is ready for further processing in the recall decision workflow.

At block 812, an assessment is made as to whether the update is attested by the user authenticated to access the recall decision sub-system 308. If this attestation is affirmative, the process 800 moves to block 814.

At block 814, execution of recall of the product identified for the recall is initiated, for example, by the recall execution sub-system 310, by notifying stakeholders of the recall. This notification process may involve multiple channels of communication, such as automated emails, text messages, or phone calls to distributors, retailers, and regulatory bodies. The recall execution sub-system 310 may also generate recall notices for public dissemination through media outlets and website of the manufacturer. Additionally, the recall execution sub-system 310 may initiate internal processes such as halting further distribution of the affected product, coordinating return logistics, and preparing customer service teams to handle inquiries. The recall execution sub-system 310 may also trigger the creation of a recall tracking dashboard to monitor the progress of the recall in real-time, including metrics such as the percentage of recalled products retrieved, and the number of customer responses received. However, if at block 812 it is determined that the update is not attested by the user authenticated to access the recall decision sub-system 308, the process 800 proceeds back to block 810. This ensures that all necessary approvals and verifications for the recall process are in place before proceeding with the recall, maintaining regulatory compliance and product safety standards.

Thus, updating the predefined information in the recall decision sub-system 308 may help in creating risk assessments for other products that may be affected by the same anomaly as the product identified for recall, even though no complaints or recall requests have been received for these other products. This allows the recall decision sub-system 308 to analyze potential risks across the product portfolio based on shared characteristics or manufacturing processes.

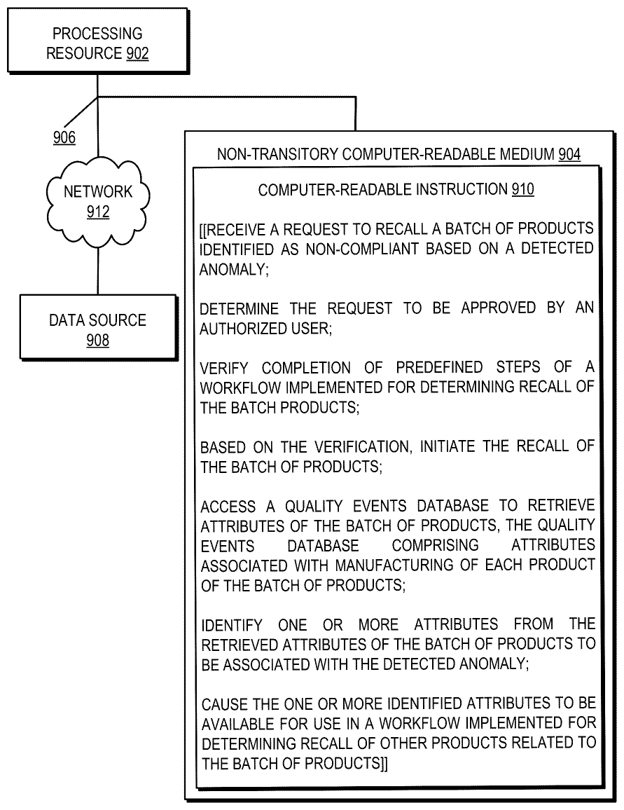

FIG. 9 illustrates a computing environment 900 for managing product recalls, according to an example implementation of the present subject matter. The computing environment 900 includes a processing resource 902 communicatively coupled to a non-transitory computer-readable medium 904 through a communication link 906. In an example, the processing resource 902 may be the processor of the product recall management system 100, 300, which fetches and executes computer-readable instructions from the non-transitory computer-readable medium 904.

The non-transitory computer-readable medium 904 may be, for example, an internal memory device or an external memory device. In an example implementation, the communication link 906 may be a direct communication link, such as any memory read/write interface. In another example implementation, the communication link 906 may be an indirect communication link, such as a network interface. In such a case, the processing resource 902 may access the non-transitory computer-readable medium 904 through a network 912. The network 912 may be a single network or a combination of multiple networks and may use a variety of different communication protocols.

The processing resource 902 and the non-transitory computer-readable medium 904 may also be communicatively coupled to data sources 908. The data source(s) 908 may be used to store data corresponding to the product recall management process, for example.

In an example implementation, the non-transitory computer-readable medium 904 comprises executable instructions 910 for enabling the management of product recalls.

According to an example implementation of the present subject matter, the instructions 910 may cause the processing resource 902 to receive, for example, at the recall execution sub-system 310 of the product recall management system 300, a request to recall a batch of products identified as non-compliant with a predefined SOP based on a detected anomaly. The anomaly may refer to any issue or defect that necessitates product recall from the market or consumer use. This may include, but is not limited to, manufacturing defects, contamination, labeling errors, or newly discovered safety concerns. The detection of such an anomaly may result from various sources, such as quality control processes, customer complaints, regulatory inspections, or internal audits.

The instructions 910 may cause the processing resource 902 to determine if the recall request is approved by an authorized user of the recall execution sub-system 310. As explained previously, this process may involve an RPM receiving and processing the request, and then forwarding it to an EM for approval. The RPM may provide a comprehensive report to the EM, including investigation status, product anomaly details, potential risks, and impact assessments. Upon EM's approval, the recall execution phase begins, involving an attestation process with multiple action items assigned to specific process owners. These action items are synchronized with corresponding items in the recall decision sub-system 308 to ensure consistency and prevent parallel execution errors.

The instructions 910 may cause the processing resource 902 to verify completion of predefined steps of a workflow implemented for determining recall of the batch of products. The predefined steps may include updating the recall decision sub-system 308 with predefined information pertaining to the batch of products identified to be recalled. This predefined information may encompass details such as manufacturing dates, lot numbers, distribution channels, and the specific nature of the anomaly prompting the recall. In an example, once the recall decision sub-system 308 is updated with the predefined information, a user of the recall decision sub-system 308 verifies the completion of the predefined steps. This verification process may involve a review of each step in the workflow, ensuring that all predefined information has been input accurately and completely in the recall decision sub-system 308.

The instructions 910 may cause the processing resource 902 to initiate, for example, by the recall execution sub-system 310, the recall of the batch of products upon verification of the completion of the predefined steps. This initiation process may involve a series of automated and manual actions, including generating official recall notifications, activating communication plans, triggering logistics for product retrieval, updating inventory systems, initiating replacement production or remediation plans, and activating monitoring systems. In an example, the recall execution sub-system 310 may also create a timestamped record of the recall initiation for regulatory compliance and legal purposes.

The instructions 910 may also cause the processing resource 902 to access a quality events database 212, for example, by the recall execution sub-system 310, to retrieve attributes of the batch of products identified for the recall. The processing resource 902 may then identify one or more attributes from the retrieved attributes of the batch of products to be associated with the detected anomaly. The instructions 910 may cause the processing resource 902 to make the one or more identified attributes available for use in a workflow implemented for determining recall of other products related to the batch of products. As explained previously, the recall execution sub-system 310 manages the recall workflow, ensuring each step is completed by authorized users. During recall execution, the recall execution sub-system 310 retrieves and compares attributes of the recalled product and related products from the quality events database 212. Using similarity scoring, the recall execution sub-system 310 determines if other products are potentially affected by the same anomaly. If the similarity score exceeds a threshold, a risk assessment is triggered for the related product, for example, by the recall decision sub-system 308. In an example, the recall execution sub-system 310 may receive and process a request to recall a batch of products independently from any risk assessment process conducted by the recall decision sub-system 308. This means the recall process may be initiated without waiting for or depending on the completion of a formal risk assessment. This process allows for parallel execution of the initial recall and assessment of other potentially affected products, enabling efficient decision-making on additional recalls.

Thus, the methods and systems of the present subject matter address the need for efficient product recall management. By enabling the recall execution sub-system to initiate recalls independently and communicate critical attribute information to the recall decision sub-system, the invention facilitates a more responsive and comprehensive approach to product safety. This integrated process allows for immediate action on identified anomalies while simultaneously triggering risk assessments for potentially affected related products. Further, the system's ability to concurrently execute recall decision and recall execution by analyzing and comparing product attributes across batches may expedite the recall execution process, while also providing more efficient recall execution by allowing for simultaneous investigation of other products based on the attributes that caused the anomaly in the product determined to be recalled by the recall execution sub-system. While specific implementations of the product recall management system have been discussed, it is to be understood that the appended claims are not necessarily limited to the specific features or methods described. Rather, the specific features and methods are disclosed as example implementations for enhancing the efficiency and effectiveness of product recall processes across various industries.

1. A method for product recall management comprising:
in a product recall management system comprising a recall decision sub-system configured to execute a workflow for a process of deciding recall of products and a recall execution sub-system configured to execute a workflow for a process of executing recall of the products, receiving, by the recall execution sub-system, a request to recall at least one product, wherein the request is based on an anomaly relating to the at least one product;
upon approval of the request, initiating, by the recall execution sub-system, execution of the recall of the at least one product;
retrieving, from a quality events database, attributes associated with manufacturing of the at least one product;
identifying, from amongst the attributes, one or more attributes that contribute to the anomaly in the at least one product; and
determining if the identified attributes affect other products related to the at least one product; and
communicating the one or more identified attributes to the recall decision sub-system to initiate a risk assessment process for the other products based on the one or more identified attributes, the risk assessment process comprising execution of the workflow for a process of deciding recall of the other products.

2. The method of claim 1, wherein the request to recall the at least one product received by the recall execution sub-system is independent of a risk assessment process carried out by the recall decision sub-system for the at least one product.

3. The method of claim 1, wherein determining if the one or more identified attributes affect other products related to the at least one product comprises assessing a degree of similarity between the one or more identified attributes of the at least one product and corresponding attributes of the other products.

4. The method of claim 3, wherein the degree of similarity is based on a weightage assigned to each of the one or more identified attributes that affect the other products.

5. The method of claim 4, wherein the weightage assigned to each of the one or more identified attributes that affect the other products is configurable based on a user input.

6. The method of claim 1, further comprising:
completion of an attestation process to update predefined information pertaining to the at least one product in the recall decision sub-system prior to the execution of the recall of the at least one product by the recall execution sub-system.

7. The method of claim 6, wherein the completion of the attestation process is verified by a user authenticated to access the recall decision sub-system of the product recall management system.

8. The method of claim 1, wherein the request to recall further comprises a compilation of reports corresponding to instances of detection of the anomaly associated with the at least one product.

9. A product recall management system, comprising:
a recall execution sub-system configured to:
receive an approval to initiate a recall of at least one product based on an anomaly relating to the at least one product;
verify the approval to be provided by a user authorized to attest completion of predefined steps of a workflow implemented by a recall decision sub-system of the product recall management system, the workflow implementing a process of determining recall of products;
initiate execution of recall of the at least one product based on the verification;
access a quality events database to retrieve attributes of the at least one product, the attributes being associated with manufacturing of the at least one product;
identify an attribute from the retrieved attributes that contributes to the anomaly in the at least one product;
determine an impact of the identified attribute on other products that are related to the at least one product;
communicate, to the recall decision sub-system, the identified attribute to initiate a risk assessment for the other products related to the at least one product.

10. The system of claim 9, wherein the recall execution sub-system is to:
determine a degree of similarity between the identified attribute of the at least one product and a corresponding attribute of the other products.

11. The system of claim 10, wherein the degree of similarity is based on a weightage assigned to the identified attribute that impacts the other products.

12. The system of claim 11, wherein the weightage assigned to the identified attribute that impacts the other products is configurable based on a user input.

13. The system of claim 9, further comprising:
completion of an attestation process to update predefined information pertaining to the at least one product in the recall decision sub-system prior to the initiation of the execution of the recall of the at least one product by the recall execution sub-system.

14. A non-transitory computer-readable medium comprising instructions executable by a processing resource to:
receive a request to recall a batch of products identified as non-compliant based on a detected anomaly;
determine the request to be approved by an authorized user;
verify completion of predefined steps of a workflow implemented for determining recall of the batch of products;
based on the verification, initiate the recall of the batch of products;
access a quality events database to retrieve attributes of the batch of products, the quality events database comprising attributes associated with manufacturing of each product of the batch of the products;
identify one or more attributes from the retrieved attributes of the batch of products to be associated with the detected anomaly;
cause the one or more identified attributes to be available for use in a workflow implemented for determining recall of other products related to the batch of products.

15. The non-transitory computer-readable medium as claimed in claim 14, further comprising instructions executable by the processing resource to assess a degree of similarity between the one or more identified attributes of the batch of products and corresponding attributes of the other products to determine if the one or more identified attributes affect the other products.

16. The non-transitory computer-readable medium as claimed in claim 15, wherein the degree of similarity is based on a weightage assigned to each of the one or more identified attributes that affect the other batches of products.

17. The non-transitory computer-readable medium as claimed in claim 16, wherein the weightage assigned to each of the one or more identified attributes that affect the other batches of products is configurable based on a user input.

18. The non-transitory computer-readable medium as claimed in claim 14, further comprising instructions executable by the processing resource to present a compilation of reports corresponding to instances of detection of the anomaly associated with the batch of products.

19. The non-transitory computer-readable medium as claimed in claim 14, further comprising instructions executable by the processing resource to verify the completion of the predefined steps prior to initiation of the recall of the batch of products.

20. The non-transitory computer-readable medium as claimed in claim 14, wherein the request to recall the batch of products received by the recall execution sub-system is independent of a risk assessment process carried out by the recall decision sub-system for the batch of products.
